(19) United States
(12) Patent Application Publication
(10) Pub. No.: US 2026/0164193 A1
(43) Pub. Date: Jun. 11, 2026

(54) HEARING AID COMPRISING AN ULTRASOUND PROCESSING UNIT

(71) Applicant: Oticon A/S, Smørum (DK)

(72) Inventors: Michael Syskind PEDERSEN, Smørum (DK); Aske Søderman HANSEN, Smørum (DK)

(21) Appl. No.: 19/408,452

(22) Filed: Dec. 4, 2025

(30) Foreign Application Priority Data
Dec. 10, 2024 (EP) 24218696.3

(51) Int. Cl. H04R 25/00

(52) U.S. Cl. CPC H04R 25/505; H04R 25/604; H04R 2430/01

(57) ABSTRACT

Disclosed are embodiments of a hearing aid including a plurality of microphones and an ultrasound processing unit. The plurality of microphones is configured to provide a corresponding plurality of electrical input signals representing a sound affected by an ultrasound in an environment of the hearing aid, the ultrasound being characterized by an ultrasound frequency. The plurality of microphones is configured to have different sensitivities towards the ultrasound frequency. The ultrasound processing unit is configured to determine, based on the different sensitivities towards the ultrasound frequency, an ultrasound reduced signal.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present application relates to the field of hearing aids. The present application relates to a hearing aid comprising an ultrasound processing unit, and a related method.

### BACKGROUND

An ultrasound is a sound with a frequency above the audible frequency range (e.g., above 20 kHz). Ultrasound emissions occur in daily life e.g., as sound emitted from one or more of: a parking sensor, a room occupancy sensor, and any other suitable sensor. Typically, such sensors emit a relatively loud ultrasound pulse train, e.g., within the frequency range of 30-50 kHz.

At higher frequencies, a microphone typically has one or more resonance frequencies coming from the microphone itself and the physical parts surrounding it. When sampling an analogue signal that is captured by the microphone at a given sample rate fₛ, signal components located at frequencies above half of the sampling rate fₛ/2may still be present in the sampled signal (e.g., digital signal) at frequencies below half of the sampling rate fₛ/2. Such effect is known as aliasing.

One option to prevent such signal components from appearing in the sample signal is to apply a Low-Pass Filter (LPF) or an anti-aliasing LPF before sampling the analogue signal. However, especially for frequencies near the one or more resonance frequencies, such signal components may still be present in the sampled signal, such as below half of the sampling rate fₛ/2. In other words, aliasing may still occur even when a LPF is applied to the analogue signal.

For a pulse-like ultrasound signal, the audible signal may sound similar to the sound of a fishing boat engine. The sound may become considerably disturbing for a user wearing the hearing aid as it is a sound only audible through the hearing aid and inaudible to everybody else.

### SUMMARY

There is a need for hearing aids and methods for reducing unwanted artifacts or sounds, in the ultrasound range, in a signal reaching the microphone of the hearing aid.

### A Hearing Aid

A hearing aid is disclosed herein. The hearing aid comprises an input unit comprising a plurality of microphones configured to provide a corresponding plurality of electrical input signals representing a sound affected by an ultrasound in an environment of the hearing aid. The ultrasound is characterized by an ultrasound frequency. Each of the plurality of electrical input signals is provided in a digitized form. The plurality of microphones is configured to have different port diameters such that sensitivities towards the ultrasound frequency are different among the plurality of microphones. The hearing aid comprises an ultrasound processing unit in communication with the input unit. The ultrasound processing unit is configured to receive the plurality of electrical input signals. The ultrasound processing unit is configured to determine, based on the different sensitivities towards the ultrasound frequency, an ultrasound processed signal. The hearing aid comprises an output unit configured to output, based on the ultrasound processed signal, an audible signal to the user wearing the hearing aid.

Thereby an improved hearing aid may be provided.

It is an advantage of the present disclosure that, by having the plurality of microphones configured to have different sensitivities towards the ultrasound frequency, an improved hearing experience is provided. For example, by having the plurality of microphones configured to have different sensitivities towards the (same) ultrasound frequency, suppression of ultrasound artifacts in the range of each of the plurality of electrical input signals (e.g., in the range of the signals reaching the plurality of microphones) can be provided in particular in a challenging ultrasound environment (e.g., in an environment of the hearing aid with substantial ultrasound interference). For example, having a plurality of electrical input signals (e.g., multiple microphone signals) can increase the probability of having one electrical input signal of the plurality of electrical input signals that is less affected by ultrasound compared to the other electrical input signals of the plurality of electrical input signals.

Embodiments of the present disclosure can advantageously enable provision of an output signal (e.g., the output of an audible signal) comprising a minor level of ultrasound (e.g., a less audible aliasing artifact), e.g., a signal less impacted by ultrasound interference, in turn improving a user's hearing experience. In particular, the level of a sound similar to a fishing boat engine (e.g., a buzzing sound) caused by presence of ultrasound in the environment of the hearing aid can be greatly reduced. Stated differently, embodiments of the present disclosure may provide for improved mitigation (e.g., reduction) of ultrasonic interference in hearing aids.

The hearing aid comprises an input unit comprising a plurality of microphones (e.g., MEMS (micro-electromechanical systems) microphones) configured to provide a corresponding plurality of electrical input signals representing a sound affected by an ultrasound in an environment of the hearing aid. Put differently, the input unit may comprise a plurality of input transducers (e.g., a plurality of microphones) configured to convert an input sound in an environment of the hearing aid to a corresponding plurality of electric input signals. The input sound may be affected by an ultrasound (e.g., an ultrasonic sound).

For example, the plurality of microphones is configured to obtain a corresponding plurality of electrical input signals. In one or more example hearing aids, the hearing aid may be configured to obtain a first electrical input signal of the plurality of electrical input signals using a first microphone of the plurality of microphones. For example, the hearing aid is configured to obtain a second electrical input signal of the plurality of electrical input signals using a second microphone of the plurality of microphones. For example, the hearing aid is configured to obtain a third electrical input signal of the plurality of electrical input signals using a third microphone of the plurality of microphones.

In one or more example hearing aids, an electrical input signal is indicative of a sound generated by the user of the hearing aid, people, or other sound sources (e.g., ultrasound sources) in the environment of the hearing device. For example, an electrical input signal may be indicative of user speech affected by an ultrasonic sound. For example, an electrical input signal may be indicative of a sound output by an electronic device (e.g., a mobile phone, a computer, a speaker) affected by an ultrasonic sound. For example, each of the plurality of electrical input signal may comprise an ultrasound component (e.g., an ultrasound signal pulse). For example, the hearing aid can comprise an ultrasound detection unit configured to detect an ultrasound component in each of the plurality of electrical input signals (e.g., by detecting a power level, such as by detecting a signal with a power level that is above a threshold for a considerable time duration, and/or by detecting a signal with a repetitive pattern). Optionally, the ultrasound detection unit can be implemented using a neural network trained on audio input samples or derived audio features labeled with ultrasound artifacts either present or absent.

In one or more example hearing aids, the input unit comprises a wireless receiver configured to receive a wireless signal comprising or representing the sound affected by an ultrasound in an environment of the hearing aid. In one or more example hearing aids, the wireless receiver is configured to provide the plurality of electric input signals representing said sound. In one or more example hearing aids, the wireless receiver is configured to receive an electromagnetic signal in the radio frequency range (e.g., 3 kHz to 300 GHz). In one or more example hearing aids, the wireless receiver may be configured to receive an electromagnetic signal in a frequency range of light (e.g., infrared light 300 GHz to 430 THz, or visible light, e.g., 430 THz to 770 THz).

In one or more example hearing aids, the input unit is configured to provide a linear combination of the plurality of electrical input signals. In other words, the input unit is configured to provide the linear combination of the plurality of electrical input signals in addition to the corresponding plurality of electrical input signals.

The ultrasound is characterized by an ultrasound frequency. Each of the plurality of electrical input signals is provided in a digitized form. In one or more example hearing aids, the hearing aid comprises an analogue-to-digital (AD) converter configured to digitize an analogue input (e.g., from an input transducer, such as a microphone) with a predefined sampling rate (e.g., 20 kHz). In other words, the AD converter may be configured to provide each of the plurality of input signals in a digitized form. In other words, the AD converter may be configured to provide each of the plurality of electrical input signals as a digitally sampled signal (e.g., a digital audio signal).

For example, each of the plurality of electrical input signals (e.g., an analogue electrical signal) may be converted to a digital audio signal in an AD conversion process, where each of the plurality of electrical input signals is sampled with a predefined sampling frequency or rate fₛ (fₛ being e.g., in the range from 8 kHz to 48 kHz) to provide digital (e.g., audio) samples xₙ (with n=1, . . . , N) at discrete points in time tₙ (with n=1, . . . , N), each digital (e.g., audio) sample representing the value of a respective electrical input signal at tₙ by a predefined number N_{b} of bits (N_{b} being e.g., in the range from 1 to 48 bits, e.g., 24 bits). The sampling frequency or rate fₛ may be adapted to the particular needs of the application. For example, each digital (e.g., audio) sample is quantized using N_{b} bits (e.g., resulting in 2^{N}^{_{b}} different possible values of the digital sample). For example, a digital sample xₙ has a length in time of 1/fₛ (e.g., 50 μs for fₛ=¿20 kHz). A number of digital (e.g., audio) samples may be arranged in a time frame. A time frame may comprise 64 or 128 audio data samples. Other frame lengths may be used depending on the practical application. For example, each of the plurality of electrical input signals comprises a number of digital samples arranged in a time frame. In other words, each of the plurality of electrical input signals comprises a plurality of time frames.

Optionally, each of the plurality of electrical input signals can be sampled with a sampling frequency or rate fₛ of e.g., 640 kHz, to provide a plurality of first digital samples. Performing the AD conversion process may comprise applying a digital LP filter to each of the plurality of first digital samples for provision of a plurality of filtered digital samples. Performing the AD conversion process may comprise downsampling each of the plurality of filtered digital samples by a given factor, e.g., by a factor of 32. In other words, an AD conversion process may include sampling an input signal at a higher frequency, followed by a digital LP filter and a downsampling process.

In one or more example hearing aids, each of the plurality of electrical input signals is a digitally sampled time-domain signal, in which the Nyquist frequency is lower than the ultrasound frequency.

The plurality of microphones is configured to have different sensitivities towards the ultrasound frequency (e.g., to the same ultrasound frequency). For example, the plurality of microphones is configured to have different sensitivities towards audible aliasing artifacts, the audible aliasing artifacts originating from the ultrasound frequency.

A sensitivity towards an ultrasound frequency may be construed as a resonance frequency in the ultrasound range which is mapped to an audible range as a spatial aliasing artifact. Optionally, a sensitivity towards an ultrasound frequency may be construed as a resonance frequency in the range of an electrical input signal, in which ultrasound is likely to occur.

For example, a microphone of the plurality of microphones having the highest sensitivity towards the (same) ultrasound frequency can be seen as a microphone having a resonance frequency (e.g., approximately) co-located with the ultrasound frequency. For example, a microphone of the plurality of microphones having the highest sensitivity towards the (e.g., same) ultrasound frequency may be seen as a microphone of the plurality of microphones the most affected by the ultrasound in the environment of the hearing aid. In other words, a microphone of the plurality of microphones having the highest sensitivity towards the ultrasound frequency may be seen as a microphone of the plurality of microphones receiving the most ultrasound (e.g., being contaminated by the most ultrasound). For example, microphone of the plurality of microphones having the highest sensitivity is a microphone configured to provide an electrical input signal which is the most contaminated and/or polluted by such ultrasound (e.g., an electrical input signal experiencing the strongest ultrasound interference).

For example, different sensitivities can be obtained by selecting microphones having different resonance frequency. Optionally, different sensitivities can be obtained by designing microphone inlets or microphone ports such that the resonance frequencies become different even though the microphones are acoustically identical. Stated differently, the difference in the port diameter may alter the combined microphone-port system, resulting in distinct overall acoustic characteristics for each microphone. For example, a port diameter can be seen as a port hole and/or a port opening.

In one or more example hearing aids, the plurality of microphones comprises a corresponding port (e.g., an inlet) having a diameter. In one or more example hearing aids, the plurality of microphones is configured to have different port diameters such that the sensitivity towards the (e.g., same) ultrasound frequency is different among such plurality of microphones. The sensitivity towards an ultrasound frequency may be controlled based on the size of the port diameter. For example, a microphone of the plurality of microphone having the lowest sensitivity (e.g., the least affected by ultrasound interference) towards the same ultrasound frequency may be a microphone comprising the smallest port diameter among the plurality of microphones. For example, a microphone of the plurality of microphone having the highest sensitivity (e.g., the most affected by ultrasound interference) towards the same ultrasound frequency may be a microphone comprising the largest port diameter among the plurality of microphones.

In one or more example hearing aids, to determine the ultrasound processed signal comprises to select, based on the comparison, the ultrasound processed signal as the electrical input signal provided by the microphone of the plurality of microphones having the smallest port diameter among the plurality of microphones. For example, the ultrasound processed signal can be determined upon a detection of ultrasound (e.g., by the ultrasound detection unit) in at least one of the plurality of electrical input signals (e.g., by detecting a power level, such as by detecting a signal with a power level that is above a threshold for a considerable time duration, and/or by detecting a signal with a repetitive pattern).

For example, smaller port diameters can increase acoustic resistance and reduce the effective bandwidth (e.g., the frequency range where the microphone can reproduce sound with minor attenuation or distortion), thereby attenuating high-frequency signals. Larger port diameters may reduce acoustic resistance in turn allowing better transmission of high-frequency signals (signals deriving from the sound picked up by the microphone), but introducing unwanted resonances (which generates ultrasound distortion). In a generalized manner, the microphone having the smallest diameter port may be associated with a smaller likelihood (in comparison with a microphone having a larger diameter port) for ultrasound artifacts, thereby being selected when ultrasound is detected (e.g., by the ultrasound detection unit) in at least one of the plurality of electrical input signals.

For example, the plurality of microphones comprise (e.g., has) different port diameters such that sensitivities towards the same ultrasound frequency are different among the plurality of microphones. For example, a first microphone of the plurality of microphones can have a port diameter of 0.15 mm and a second microphone of the plurality of microphones can have a port diameter of 0.25 mm.

In one or more example hearing aids, each microphone can be configured to have a plurality of sensitivities towards a corresponding plurality of ultrasound frequencies. For example, the plurality of microphones can be configured to have different sensitivities towards different ultrasound frequencies.

Optionally, different port diameters may have different sensitivities across different frequency regions such that the microphone of the plurality of microphones with the largest port diameter may be selected in one frequency regions whereas the microphone of the plurality of microphones with the smallest port diameter may be selected in another frequency region.

For example, a first microphone of the plurality of microphones is configured to have a first primary sensitivity (e.g., s_{1,1}) towards a first ultrasound frequency (e.g., f_{UL 1}). For example, a second microphone of the plurality of microphones is configured to have a first secondary sensitivity (e.g., s_{1,2}) towards the first ultrasound frequency (e.g., f_{UL 1}). For example, a third microphone of the plurality of microphones is configured to have a first tertiary sensitivity (e.g., s_{1,3}) towards the first ultrasound frequency (e.g., f_{UL 1}). The first primary sensitivity may be different from the first secondary sensitivity (e.g., s_{1,1}≠s_{1,2}). The first tertiary sensitivity may be different from the first primary sensitivity (e.g., s_{1,3}≠s_{1,1}). The first tertiary sensitivity may be different from the first secondary sensitivity (e.g., s_{1,3}≠s_{1,2}).

In one or more example hearing aids, the hearing aid comprises a memory unit configured to store the different sensitivities of the plurality of microphones. For example, the memory unit is configured to store one or more of: the first primary sensitivity, the second primary sensitivity, and the first secondary sensitivity.

As used herein, the ultrasound in the environment of the hearing aid is characterized by the first ultrasound frequency (e.g., f_{UL 1}). For example, the first microphone is the microphone of the plurality of microphones having the highest sensitivity when the first primary sensitivity is higher than the first secondary sensitivity and the first tertiary sensitivity (e.g., s_{1,1}>s_{1,2} and s_{1,1}>s_{1,3}). Put differently, the first electrical input signal may experience the strongest ultrasound interference in comparison to the second electrical input signal and the third electrical input signal when the first primary sensitivity is higher than the first secondary sensitivity and the first tertiary sensitivity. For example, the first microphone is the microphone of the plurality of microphones that is most affected by ultrasound interference when the ultrasound in the environment of the hearing aid is characterized by the first ultrasound frequency (e.g., f_{UL 1}). For example, the first microphone comprises the largest port diameter among the plurality of microphones when the ultrasound in the environment of the hearing aid is characterized by the first ultrasound frequency (e.g., f_{UL 1}).

For example, the second microphone is the microphone of the plurality of microphones having the highest sensitivity when the first secondary sensitivity is higher than the first primary sensitivity and the first tertiary sensitivity (e.g., s_{1,2}>s_{1,1} and s_{1,2}>s_{1,3}). Put differently, the second electrical input signal may experience the strongest ultrasound interference in comparison to the first electrical input signal and the third electrical input signal when the first secondary sensitivity is higher than the first primary sensitivity and the first tertiary sensitivity. For example, the second microphone is the microphone of the plurality of microphones that is most affected by ultrasound interference when the ultrasound in the environment of the hearing aid is characterized by the first ultrasound frequency (e.g., f_{UL 1}). For example, the second microphone comprises the largest port diameter among the plurality of microphones when the ultrasound in the environment of the hearing aid is characterized by the first ultrasound frequency (e.g., f_{UL 1}).

For example, the third microphone is the microphone of the plurality of microphones having the highest sensitivity when the first tertiary sensitivity is higher than the first primary sensitivity and the first secondary sensitivity (e.g., s_{1,3}>s_{1,1} and s_{1,3}>s_{1,2}). Put differently, the third electrical input signal may experience the strongest ultrasound interference in comparison to the first electrical input signal and the second electrical input signal when the first tertiary sensitivity is higher than the first primary sensitivity and the first secondary sensitivity. For example, the third microphone is the microphone of the plurality of microphones that is most affected by ultrasound interference when the ultrasound in the environment of the hearing aid is characterized by the first ultrasound frequency (e.g., f_{UL 1}). For example, the third microphone comprises the largest port diameter among the plurality of microphones when the ultrasound in the environment of the hearing aid is characterized by the first ultrasound frequency (e.g., f_{UL 1}).

In a generalized manner, a microphone of the plurality of microphones configured to have the highest sensitivity towards a specific ultrasound frequency may comprise the largest port diameter in a frequency range including the specific ultrasound frequency.

Optionally, a small port diameter size may result in a higher sensitivity in a certain ultrasound frequency range (e.g., including the first ultrasound frequency) and a large port diameter may result in a higher sensitivity in another ultrasound frequency range (e.g., including a second ultrasound frequency different from the first ultrasound frequency).

For example, the first microphone which comprises the largest port diameter can be the most affected in a frequency range including the first ultrasound frequency (e.g., thereby having the highest sensitivity towards the first ultrasound frequency), whereas the second microphone or the third microphone (e.g., depending on which of the second and third microphones has the highest sensitivity towards the second ultrasound frequency) can be the most affected in a frequency range including the second ultrasound frequency even when having the smallest port diameter among the plurality of microphones. For example, the first microphone having the largest port diameter can be the most affected by the first ultrasound frequency and the second microphone (e.g., or the third microphone) having the smallest port diameter can be the most affected by the second ultrasound frequency.

The hearing aid comprises an ultrasound processing unit in communication with the input unit. The ultrasound processing unit is configured to receive the plurality of electrical input signals (e.g., and/or the linear combination of the plurality of electrical input signals). The ultrasound processing unit is configured to determine, based on the different sensitivities towards the ultrasound frequency (e.g., the first ultrasound frequency), an ultrasound processed signal (e.g., an ultrasound reduced signal). In one or more example hearing aids, the ultrasound processing unit is configured to determine the ultrasound processed signal based on the plurality of electrical input signals. In one or more example hearing aids, the ultrasound processing unit is configured to determine the ultrasound processed signal based on the different sensitives towards the ultrasound frequency (e.g., the first ultrasound frequency) and the plurality of electrical input signals.

The hearing aid comprises an output unit configured to output, based on the ultrasound processed signal, an audible signal to the user wearing the hearing aid.

In one or more example hearing aids, the output unit is configured to provide a stimulus perceived by the user as an acoustic signal based on the ultrasound processed signal. The output unit may comprise an output transducer. The output transducer may comprise a receiver (e.g., a loudspeaker) for providing the stimulus as an acoustic signal to the user (e.g., in an acoustic (air conduction based) hearing aid).

The output unit may (additionally or alternatively) comprise a (e.g., wireless) transmitter for transmitting sound picked up-by the hearing aid to another device, e.g. a far-end communication partner (e.g., via a network, e.g., in a telephone mode of operation). In one or more example hearing aids, the wireless transmitter is configured to transmit an electromagnetic signal in the radio frequency range (e.g., 3 kHz to 300 GHz). The wireless transmitter may be configured to transmit an electromagnetic signal in a frequency range of light (e.g., infrared light 300 GHz to 430 THz, or visible light, e.g., 430 THz to 770 THz).

In one or more example hearing aids, the hearing aid comprises a digital-to-analogue (DA) converter to convert a digital signal to an analogue output signal, e.g., for being presented to a user via the output unit (e.g., output transducer). In other words, the DA converter may be configured to convert the ultrasound processed signal as a digital signal, e.g., provided in a digitized form by the ultrasound processing unit, to an analogue output signal. The analogue output signal may be converted into an acoustic signal via the output transducer.

In one or more example hearing aids, each of the plurality of electrical input signals is a time-domain signal or a frequency-domain signal. In one or more example hearing aids, each of the plurality of electrical input signals is a time-domain signal. In one or more example hearing aids, each of the plurality of electrical input signals is a frequency-domain signal.

In one or more example hearing aids, to determine the ultrasound processed signal comprises to compare the sensitivity associated with each of the plurality of microphones. In one or more example hearing aids, to determine the ultrasound processed signal comprises to select, based on the comparison, the ultrasound processed signal as the electrical input signal provided by the microphone of the plurality of microphones with the lowest sensitivity. For example, the ultrasound processed unit is configured to determine the ultrasound processed signal based on the sensitivity associated with each of the plurality of microphones. In one or more example hearing aids, to determine the ultrasound processed signal comprises to select the ultrasound processed signal as the first electrical input signal when the first primary sensitivity is lower than the second primary sensitivity and the first tertiary sensitivity (e.g., when s_{1,1}<s_{1,2} and s_{1,1}<s_{1,3}). In one or more example hearing aids, to determine the ultrasound processed signal comprises to select the ultrasound processed signal as the second electrical input signal when the first secondary sensitivity is lower than the first primary sensitivity and the first tertiary sensitivity (e.g., when s_{1,2}<s_{1,1} and s_{1,2}<s_{1,3}). In one or more example hearing aids, to determine the ultrasound processed signal comprises to select the ultrasound processed signal as the third electrical input signal when the first tertiary sensitivity is lower than the first primary sensitivity and the first secondary sensitivity (e.g., when s_{1,3}<s_{1,1} and s_{1,3}<s_{1,2}).

In one or more example hearing aids, to determine the ultrasound processed signal comprises to determine a magnitude associated with each of the plurality of electrical input signals. In one or more example hearing aids, to determine the ultrasound processed signal comprises to compare the magnitude associated with each of the plurality of electrical input signals. In one or more example hearing aids, to determine the ultrasound processed signal comprises to select, based on the comparison, the ultrasound processed signal as the electrical input signal of the plurality of electrical input signals comprising the lowest magnitude. For example, the ultrasound processed unit is configured to determine the ultrasound processed signal based on the magnitude associated with each of the plurality of electrical input signals.

In one or more example hearing aids, to determine the ultrasound processed signal comprises to determine the magnitude of the first electrical input signal, e.g., to determine a first magnitude (e.g., m₁). In one or more example hearing aids, to determine the ultrasound processed signal comprises to determine the magnitude of the second electrical input signal, e.g., to determine a second magnitude (e.g., m₂). In one or more example hearing aids, to determine the ultrasound processed signal comprises to determine the magnitude of the third electrical input signal, e.g., to determine a third magnitude (e.g., m₃).

For example, the magnitude can be construed as a power, an energy and/or an amplitude. For example, determining the magnitude associated with each of the plurality of electrical input signals comprises applying an absolute operator (e.g., ABS operator) to each of the plurality of electrical input signal. For example, determining the magnitude of an electrical input signal comprises determining the absolute value of each element of such electrical input signal, such as a positive amplitude of each element of such electrical input signal (e.g., |xₙ|, with n=1, . . . , N). In other words, the magnitude of an electrical input signal may be construed as a set of magnitudes, such as a magnitude vector (e.g., a vector comprising a plurality of absolute values and/or absolute-squared values). For example, determining the magnitude of an electrical input signal comprises determining a single magnitude value, such as determining the energy N and/or power of such electrical input signal, e.g., a magnitude-squared (e.g., yₙ=Σ|xₙ|², with n=1 , . . . , N or implemented using a recursive filter: yₙ=(1−α)yₙ₋₁+α|xₙ|², with 0≤α≤1). In one or more example hearing aids, the ultrasound processing unit is configured to generate a plurality of magnitude input signals and/or a plurality of magnitude-squared input signals. For example, the magnitude of an electrical input signal and/or of the magnitude-squared of an electrical input signal can be determined for separate frequency channels when the electrical input signal is a frequency-domain signal or for a time-domain signal. For example, the magnitude of an electrical input signal and/or of the magnitude-squared of an electrical input signal N can be determined as an average across time frames, e.g., either as a moving average (e.g., Σ(1/N)|xₙ|²) or as a recursive average (e.g., implemented by a first order infinite impulse response 1 (IIR) filter).

In one or more example hearing aids, to determine the ultrasound processed signal comprises to compare the first magnitude, the second magnitude and the third magnitude with one another. For example, to determine the ultrasound processed signal comprises to compare the first magnitude with the second magnitude. For example, to determine the ultrasound processed signal comprises to compare the first magnitude with the third magnitude. For example, to determine the ultrasound processed signal comprises to compare the first magnitude with the second magnitude. For example, to determine the ultrasound processed signal comprises to compare the second magnitude with the third magnitude.

In one or more example hearing aids, to determine the ultrasound processed signal comprises to select the ultrasound processed signal as the first electrical input signal when the first magnitude is lower than the second magnitude and the third magnitude (e.g., when m₁<m₂ and m₁<m₃). For example, the first electrical input signal is the electrical input signal of the plurality of electrical input signals the least contaminated by the ultrasound in the environment of the hearing aid (e.g., least affected by ultrasound interference). In other words, the first microphone may be the microphone having the lowest sensitivity towards the ultrasound frequency (e.g., the first ultrasound frequency), such as the microphone comprising the smallest port diameter among the plurality of microphones when the ultrasound frequency is the first ultrasound frequency.

In one or more example hearing aids, to determine the ultrasound processed signal comprises to select the ultrasound processed signal as the second electrical input signal when the second magnitude is lower than the first magnitude and the third magnitude (e.g., when m₂<m₁ and m₂<m₃). For example, the second electrical input signal is the electrical input signal least contaminated by the ultrasound in the environment of the hearing aid. For example, the second electrical input signal is the electrical input signal of the plurality of electrical input signals the least contaminated by the ultrasound in the environment of the hearing aid (e.g., least affected by ultrasound interference). In other words, the second microphone may be the microphone having the lowest sensitivity towards the ultrasound frequency (e.g., the first ultrasound frequency), such as the microphone comprising the smallest port diameter among the plurality of microphones when the ultrasound frequency is the first ultrasound frequency.

In one or more example hearing aids, to determine the ultrasound processed signal comprises to select the ultrasound processed signal as the third electrical input signal when the third magnitude is lower than the first magnitude and the second magnitude (e.g., when m₃<m₁ and m₃<m₂). For example, the third electrical input signal is the electrical input signal of the plurality of electrical input signals the least contaminated by the ultrasound in the environment of the hearing aid (e.g., least affected by ultrasound interference). In other words, the third microphone may be the microphone having the lowest sensitivity towards the ultrasound frequency (e.g., the first ultrasound frequency), such as the microphone comprising the smallest port diameter among the plurality of microphones when the ultrasound frequency is the first ultrasound frequency.

In one or more example hearing aids, an electrical input signal comprising a higher portion of ultrasound interference may exhibit a higher increase in its overall magnitude (e.g., energy, power, average amplitude). In other words, the electrical input signal least polluted by the ultrasound in the environment (e.g., by an ultrasound signal pulse) may be the electrical input signal comprising the least magnitude. For example, a microphone having the lowest sensitivity towards the ultrasound frequency is configured to provide the electrical input signal comprising the least magnitude.

Optionally, at least one of the plurality of electrical input signals comprises an ultrasound component. Stated differently, at least one of the plurality of electrical input signals may be representative of a sound affected by an ultrasound in the environment of the hearing aid. The remaining electrical input signals of the plurality of input signals may be representative of a sound that is not affected by the ultrasound in the environment of the hearing aid. The ultrasound detection unit may be configured to determine whether or not an electrical input signal of the plurality of electrical input signals comprises an ultrasound component. In other words, the hearing aid (e.g., the ultrasound detection unit) may be configured to detect ultrasound artifacts on at least one of the plurality of electrical input signals (e.g., on sampled versions of at least one of the plurality of electrical input signals).

For example, the ultrasound processing unit is configured to select the ultrasound processed signal as the electrical input signal comprising no ultrasound artifacts when the ultrasound detection unit does not detect an ultrasound component in an electrical input signal of the plurality of electrical input signals. For example, the ultrasound processing unit is configured to select the ultrasound processed signal as a (e.g., linear) combination of at least two of the plurality of electrical input signals, the at least two of the plurality of electrical input signals comprising no ultrasound artifacts, when the ultrasound detection unit does not detect an ultrasound component in the at least two of the plurality of electrical input signals. For example, the ultrasound processing unit is configured to select the ultrasound processed signal as the electrical input signal comprising the least ultrasound aliasing when the ultrasound detection unit does not detect an ultrasound component in each of the plurality of electrical input signals. For example, combining at least two of the plurality of electrical input signals, the at least two of the plurality of electrical input signals comprising no or minor ultrasound artifacts, can lead to improved directionality (e.g., allowing taking advantage of directional noise reduction).

In one or more example hearing aids, the ultrasound detection unit can comprise an ultrasound audibility function (e.g., unit and/or module). An ultrasound audibility function may be construed as a frequency-dependent weighting function based on audibility and/or perceived severity of the ultrasound artifact. The ultrasound audibility function may be configured to filter each of the electrical input signals before performing magnitude determination of each of the plurality of electrical input signals.

For example, the ultrasound audibility function is configured to determine how audible the ultrasound is to the user of the hearing aid. For example, the ultrasound processing unit is configured to, upon receiving from the ultrasound detection unit that the ultrasound in the environment of the hearing aid is not audible in at least two the plurality of the microphones, combine the least two of the plurality of electrical input signals (e.g., using a beamforming unit). For example, determining that the ultrasound in the environment of the hearing aid is not audible in at least two the plurality of the microphones may comprise determining that the least two of the plurality of electrical input signals comprise no or minor ultrasound artifacts.

For example, a minor ultrasound artifact can be seen as a small or subtle distortion in an electrical input signals (e.g., a digitally sampled signal) that does not significantly impact the user's hearing experience. Ultrasound audibility may be assessed for each of the plurality of microphones (e.g., in turn having a plurality of audibility-based sensitivity parameters) or on a signal derived from a linear combination of at least two electrical input signals of the plurality of electrical input signals (e.g., in turn having an overall audibility-based sensitivity parameter).

For example, determining how audible the ultrasound is to the user of the hearing aid can comprise determining whether the ultrasound is audible compared to the surrounding sound scene (e.g., environment of the hearing aid). For example, in a noisy background (e.g. at high input levels), an ultrasound artifact may be masked by the ambient sound. In such scenario, there may be no need to select the microphone of the plurality of microphones having the least ultrasound. As background noise may be the biggest issue in such a scenario, the user of the hearing aid may benefit more from keeping the plurality of microphone signals in order to apply a directionality algorithm (e.g., a beamforming technique). For example, a minor ultrasound artifact may have an ultrasound signal level equal to or less than 50 dB. In other words, a minor ultrasound artifact may be no louder than 50 dB, such as being audible in quiet, but inaudible in ambient noise. For example, ultrasound artifacts may only be suppressed at low input levels.

The ultrasound audibility function may be configured to determine the plurality of audibility parameters based on the sound level of the corresponding plurality of electrical input signals (e.g., microphone signals). The ultrasound audibility function may be configured to determine the overall audibility-based sensitivity parameter based on the sound level of a combined version of at least two of the plurality of electrical input signals. The ultrasound audibility function may be configured to determine the plurality of audibility parameters based on an estimate of the ultrasound signal level related to each of the plurality of electrical input signals (e.g., obtained based on a residual signal determined by subtracting the at least two electrical input signals of the plurality of electrical input signals).

In one or more example hearing aids, the input unit (e.g., or the antenna and transceiver circuitry) comprises a plurality of time-frequency (TF) conversion units configured to provide a TF representation of a corresponding input signal. In one or more example hearing aids, each of the plurality of TF conversion unit is in communication with a corresponding microphone of the plurality of microphones.

The TF representation may comprise an array or map of corresponding complex or real values of an input signal in a given time and frequency range. The TF conversion unit may comprise a filter bank configured to filter an input signal (e.g., a time varying signal) and providing a number of output signals (e.g., time varying output signals), each of the output signal comprising a distinct frequency range of the input signal. For example, the TF conversion unit comprises a Fourier transformation unit (e.g., a Discrete Fourier Transform (DFT) algorithm, a Short Time Fourier Transform (STFT) algorithm, a Fast Fourier Transform (FFT) algorithm or any other suitable algorithm) for converting a time variant input signal to a (time variant) signal in the (time-)frequency domain. The frequency range considered by the hearing aid from a minimum frequency fₘᵢₙ to a maximum frequency fₘₐₓ may comprise a part of the typical human audible frequency range from 20 Hz to 20 kHz (e.g., a part of the range from 20 Hz to 12 kHz). For example, a sample rate fₛ is larger than or equal to twice the maximum frequency fₘₐₓ, fₛ≥2fₘₐₓ. Each of the plurality of electrical input signals may be split into a number NI of frequency bands (e.g., of uniform width), where ¿ is e.g., larger than 5, such as larger than 10, such as larger than 50, such as larger than 100, such as larger than 500, at least some of which are processed individually. The hearing aid may be configured to process each of the plurality of electrical input signals in a number NP of different frequency channels (NP≤∈¿). The frequency channels may be uniform or non-uniform in width (e.g., increasing in width with frequency), overlapping or non-overlapping.

In one or more example hearing aids, each of the plurality of electrical input signals is a frequency-domain signal in a time-frequency (TF) representation. For example, each of the plurality of TF conversion units (e.g., analysis filter banks) may be configured to provide the corresponding plurality of electrical input signals in a TF representation, such as to provide the corresponding plurality of electrical input signals as frequency-domain signals. In other words, plurality of TF conversion units may be configured to convert the corresponding plurality of electrical input signals (e.g., in the time-domain) into a corresponding plurality of frequency domain signals. For example, the input unit comprises a separate analysis filter bank for each of the plurality of microphones. In one or more example hearing aids, a TF representation comprises a plurality of TF bins (e.g., a plurality of frequency bands and a plurality of time instances). For example, each TF bin is associated with a frequency band and a time instance. In one or more example hearing aids, a TF bin can be seen as a portion (e.g., a part) of an electrical input signal, such portion being associated with a given frequency band and a time instance.

In one or more example hearing aids, the plurality of electrical input signals comprises a first frequency-domain signal having a first plurality of TF bins (e.g., a first TF grid) and a second frequency-domain signal having a second plurality of TF bins (e.g., a second TF grid). The first frequency-domain signal may be seen as the first electrical input signal (e.g., provided by the first microphone) in the frequency domain (e.g., converted into the frequency domain via a first analysis filter bank). For example, the first frequency-domain signal is associated with the first TF grid. The second frequency domain signal may be seen as the second electrical input signal (e.g., provided by the second microphone) in the frequency domain (e.g., converted into the frequency domain via a second analysis filter bank). For example, the second frequency-domain signal is associated with the second TF grid.

In one or more example hearing aids, a pair of TF bins comprises a first TF bin of the first plurality of TF bins and a corresponding second TF bin of the second plurality of TF bins. For example, the first TF bin is associated with a first frequency band and a first time instance. For example, the second TF bin is associated with a second frequency band and a second time instance. The first time instance may be the same as the second time instance. The first frequency band may be the same as the second frequency band. In other words, the first TF bin and the second TF bin share the same location (e.g., position) in the first plurality of TF bins and second plurality of TF bins respectively. For example, the first TF bin and the second TF bins share the same location in the first TF grid and the second TF grid respectively.

In one or more example hearing aids, to determine the ultrasound processed signal comprises to select the TF bin comprising the lowest TF magnitude of each pair of TF bins. For example, each pair of TF bins is associated with the same frequency band and the same time instant (e.g., but comprised in different TF grids). In one or more example hearing aids, a TF magnitude of a TF bin can be seen as the magnitude (e.g., spectral energy, power and/or amplitude) of a portion of an electrical input signal.

Embodiments of the present disclosure advantageously can provide for ultrasound suppression in the frequency domain. In other words, embodiments of the present disclosure can allow selection of a portion of an electrical input signal the least polluted by an ultrasound signal pulse (e.g., ultrasound interference) in the frequency domain. In other words, embodiments of the present disclosure may allow selection of frequency bands, where ultrasound aliasing is likely to be audible. For example, such selection in the frequency domain can be beneficial since an ultrasound artifact caused by such ultrasound signal pulse may be a narrowband phenomenon. Additionally, such selection in the frequency domain (e.g., an analysis across frequency) may be advantageous in that the sensitivity of a microphone towards the ultrasound artifact may be based on the ultrasound frequency.

For example, embodiments of the present disclosure advantageously can allow combination at least two of the plurality of electrical input signals (e.g., frequency domain signals) when the ultrasound detection unit determines that the at least two of the plurality of electrical input signals comprise no or minor ultrasound artifacts, leading to improved directionality (e.g., allowing taking advantage of directional noise reduction).

In one or more example hearing aids, to select the TF bin comprising the lowest TF magnitude of each pair of TF bins comprises to determine a first TF magnitude of the first TF bin of each pair of TF bins. In one or more example hearing aids, to select the TF bin comprising the lowest TF magnitude of a pair of TF bins (e.g., of the plurality of TF pairs) comprises to determine the magnitude of a first TF bin of such pair of TF bins. The first TF magnitude may be seen as the magnitude of the first TF bin of such pair of TF bins. In other words, to select the TF bin comprising the lowest TF magnitude of a pair of TF bins (e.g., of the plurality of TF bins) comprises to determine the magnitude of a corresponding portion of the first frequency-domain signal (e.g., the first electrical input signal).

In one or more example hearing aids, the plurality of TF bins comprises a first pair of TF bins, a second pair of TF bins, a third pair of TF bins, etc. For example, to select the TF bin comprising the lowest TF magnitude of a first pair of TF bins (e.g., of a plurality of TF pairs) comprises to determine the magnitude of the first TF bin of such first pair of TF bins. The first TF magnitude may be seen as the magnitude of the first TF bin of such first pair of TF bins. In other words, to select the TF bin comprising the lowest TF magnitude of the first pair of TF bins comprises to determine the magnitude of a first primary portion of the first frequency-domain signal. For example, to select the TF bin comprising the lowest TF magnitude of a second pair of TF bins (e.g., of a plurality of TF pairs) comprises to determine the magnitude of the first TF bin of such second pair of TF bins. The first TF magnitude may be seen as the magnitude of the first TF bin of such second pair of TF bins. In other words, to select the TF bin comprising the lowest TF magnitude of the second pair of TF bins comprises to determine the magnitude of a first secondary portion of the first frequency-domain signal. For example, to select the TF bin comprising the lowest TF magnitude of a third pair of TF bins (e.g., of a plurality of TF pairs) comprises to determine the magnitude of the first TF bin of such third pair of TF bins. The first TF magnitude may be seen as the magnitude of the first TF bin of such first pair of TF bins. In other words, to select the TF bin comprising the lowest TF magnitude of the third pair of TF bins comprises to determine the magnitude of a first tertiary portion of the frequency-domain signal.

In one or more example hearing aids, to select the TF bin comprising the lowest TF magnitude of each pair of TF bins comprises to determine a second TF magnitude of the second TF bin of each pair of TF bins. In one or more example hearing aids, to select the TF bin comprising the lowest TF magnitude of a pair of TF bins (e.g., of the plurality of TF pairs) comprises to determine the magnitude of a second TF bin of such pair of TF bins. The second TF magnitude may be seen as the magnitude of the second TF bin of such pair of TF bins. In other words, to select the TF bin comprising the lowest TF magnitude of a pair of TF bins (e.g., of the plurality of TF bins) comprises to determine the magnitude of a corresponding portion of the second frequency-domain signal (e.g., the second electrical input signal).

For example, to select the TF bin comprising the lowest TF magnitude of a first pair of TF bins (e.g., of a plurality of TF pairs) comprises to determine the magnitude of the second TF bin of such first pair of TF bins. The second TF magnitude may be seen as the magnitude of the second TF bin of such first pair of TF bins. In other words, to select the TF bin comprising the lowest TF magnitude of the first pair of TF bins comprises to determine the magnitude of a second primary portion of the second frequency-domain signal. For example, to select the TF bin comprising the lowest TF magnitude of a second pair of TF bins (e.g., of a plurality of TF pairs) comprises to determine the magnitude of the second TF bin of such second pair of TF bins. The second TF magnitude may be seen as the magnitude of the second TF bin of such second pair of TF bins. In other words, to select the TF bin comprising the lowest TF magnitude of the second pair of TF bins comprises to determine the magnitude of a second secondary portion of the second frequency-domain signal. For example, to select the TF bin comprising the lowest TF magnitude of a third pair of TF bins (e.g., of a plurality of TF pairs) comprises to determine the magnitude of the second TF bin of such third pair of TF bins. The second TF magnitude may be seen as the magnitude of the second TF bin of such third pair of TF bins. In other words, to select the TF bin comprising the lowest TF magnitude of the third pair of TF bins comprises to determine the magnitude of a second tertiary portion of the second frequency-domain signal.

In one or more example hearing aids, to select the TF bin comprising the lowest TF magnitude of each pair of TF bins comprises to determine, for each pair of TF bins, whether the first TF magnitude is greater than the second TF magnitude. For example, to select the TF bin comprising the lowest TF magnitude of a pair of TF bins comprises to determine, for a pair of TF bins (e.g., of the plurality of TF bins), whether the first TF magnitude is greater than the second TF magnitude.

In one or more example hearing aids, to determine whether the first TF magnitude is greater than the second TF magnitude comprises to determine that the first TF magnitude is greater than the second TF magnitude. In one or more example hearing aids, to determine whether the first TF magnitude is greater than the second TF magnitude comprises to, upon determining that the first TF magnitude is greater than the second TF magnitude, select the second TF bin as the TF bin comprising the lowest TF magnitude of each pair of TF bins. In one or more example hearing aids, selecting a second TF bin of a pair of TF bins as the TF bin comprising the lowest TF magnitude includes selecting a corresponding portion of the second frequency-domain signal (e.g., the second electrical input signal) to be part of the ultrasound processed signal. For example, the ultrasound processing unit is configured to determine (e.g., generate) the ultrasound processed signal using such corresponding portion of the second frequency-domain signal. For example, the ultrasound processing unit may be configured to determine the ultrasound processed signal by including such corresponding portion of the second frequency-domain signal in a matrix (e.g., vector) representative of the ultrasound processed signal. For example, the ultrasound processed signal can be seen as a matrix (e.g., vector) comprising a plurality of portions of the second frequency-domain signal.

For example, selecting the second TF bin as the TF bin comprising the lowest TF magnitude of the first pair of TF bins includes selecting a second primary portion of the second frequency-domain signal to be part of the ultrasound processed signal. Such second primary portion of the second frequency-domain signal may contain a lower quantity of ultrasound interference (e.g., less affected by the ultrasound) in comparison with the first primary portion of the first frequency-domain signal. For example, selecting the second TF bin as the TF bin comprising the lowest TF magnitude of the second pair of TF bins includes selecting a second secondary portion of the second frequency-domain signal to be part of the ultrasound processed signal. Such second secondary portion of the second frequency-domain signal may contain a lower quantity of ultrasound interference (e.g., less affected by the ultrasound) in comparison with the first secondary portion of the first frequency-domain signal. For example, selecting the second TF bin as the TF bin comprising the lowest TF magnitude of the third pair of TF bins includes selecting a second tertiary portion of the second frequency-domain signal to be part of the ultrasound processed signal. Such second tertiary portion of the second frequency-domain signal may contain a lower quantity of ultrasound interference (e.g., less affected by the ultrasound) in comparison with the first tertiary portion of the first frequency-domain signal.

In one or more example hearing aids, to determine whether the first TF magnitude is greater than the second TF magnitude comprises to determine that the first TF magnitude is less than the second TF magnitude. In one or more example hearing aids, to determine whether the first TF magnitude is greater than the second TF magnitude comprises to, upon determining that the first TF magnitude is less than the second TF magnitude, select the first TF bin as the TF bin comprising the lowest TF magnitude of each pair of TF bins. In one or more example hearing aids, selecting a first TF bin of a pair of TF bins as the TF bin comprising the lowest TF magnitude includes selecting a corresponding portion of the first frequency-domain signal (e.g., the first electrical input signal) to be part of the ultrasound processed signal. For example, the ultrasound processing unit is configured to determine (e.g., generate) the ultrasound processed signal using such corresponding portion of the first frequency-domain signal. For example, the ultrasound processing unit may be configured to determine the ultrasound processed signal by including such corresponding portion of the first frequency-domain signal in a vector representative of the ultrasound processed signal. For example, the ultrasound processed signal can be seen as a vector comprising a plurality of portions of the first frequency-domain signal.

For example, selecting the first TF bin as the TF bin comprising the lowest TF magnitude of the first pair of TF bins includes selecting a first primary portion of the first frequency-domain signal to be part of the ultrasound processed signal. Such first primary portion of the first frequency-domain signal may contain a lower quantity of ultrasound interference (e.g., less affected by the ultrasound) in comparison with the second primary portion of the second frequency-domain signal. For example, selecting the first TF bin as the TF bin comprising the lowest TF magnitude of the second pair of TF bins includes selecting a first secondary portion of the first frequency-domain signal to be part of the ultrasound processed signal. Such first secondary portion of the first frequency-domain signal may contain a lower quantity of ultrasound interference (e.g., less affected by the ultrasound) in comparison with the second secondary portion of the second frequency-domain signal. For example, selecting the first TF bin as the TF bin comprising the lowest TF magnitude of the third pair of TF bins includes selecting a first tertiary portion of the first frequency-domain signal to be part of the ultrasound processed signal. Such first tertiary portion of the first frequency-domain signal may contain a lower quantity of ultrasound interference (e.g., less affected by the ultrasound) in comparison with the second tertiary portion of the second frequency-domain signal.

In one or more example hearing aids, to determine whether the first TF magnitude is greater than the second TF magnitude comprises to determine that the first TF magnitude is equal the second TF magnitude. In one or more example hearing aids, to determine whether the first TF magnitude is greater than the second TF magnitude comprises to, upon determining that the first TF magnitude is equal to the second TF magnitude, select the first TF bin of the pair of TF bins or the second TF bin as the TF bin comprising the lowest TF magnitude of each pair of TF bins. In one or more example hearing aids, selecting either the second TF bin or the first TF bin of a pair of TF bins as the TF bin comprising the lowest TF magnitude includes selecting a portion of the second frequency-domain signal or a portion of the first frequency domain signal to be part of the ultrasound processed signal, respectively. For example, the ultrasound processing unit is configured to determine (e.g., generate) the ultrasound processed signal using either a portion of the second frequency-domain signal or a portion of the first frequency-domain signal. Such portions of the second frequency-domain signal and the first frequency-domain signal may be equally (e.g., approximately) polluted by ultrasound interference when compared to one another.

For example, selecting either the second TF bin or the first TF bin of a first pair of TF bins as the TF bin comprising the lowest TF magnitude includes selecting a second primary portion of the second frequency-domain signal or a first primary portion of the first frequency-domain signal to be part of the ultrasound processed signal. Such second primary portion of the second frequency-domain signal and first primary portion of the first frequency-domain signal may be equally (e.g., approximately) polluted by ultrasound interference when compared to one another. For example, selecting the second TF bin or the first TF bin of a second pair of TF bins as the TF bin comprising the lowest TF magnitude includes selecting a second secondary portion of the second frequency-domain signal or a first secondary portion of the first frequency-domain signal to be part of the ultrasound processed signal. Such second secondary portion of the second frequency-domain signal and first secondary portion of the first frequency-domain signal may be equally (e.g., approximately) polluted by ultrasound interference when compared to one another. For example, selecting either the second TF bin or the first TF bin of a third pair of TF bins as the TF bin comprising the lowest TF magnitude includes selecting a second tertiary portion of the second frequency-domain signal or a first tertiary portion of the first frequency-domain signal to be part of the ultrasound processed signal. Such second tertiary portion of the second frequency-domain signal and first tertiary portion of the first frequency-domain signal may be equally (e.g., approximately) polluted by ultrasound interference when compared to one another.

In one or more example hearing aids, the ultrasound processing unit is configured to determine the ultrasound processed signal using a plurality of portions of the first frequency-domain signal (e.g., the first electrical input signal) and/or the second frequency-domain signal (e.g., the second electrical input signal). In other words, the ultrasound processed signal may be seen as a vector comprising a plurality of portions of the first frequency-domain signal and/or the second frequency-domain signal.

In one or more example hearing aids, the ultrasound processing unit comprises a plurality of filtering units configured to receive the corresponding plurality of electrical input signals. In one or more examples, a filtering unit is a Low Pass Filter (LPF). In one or more example hearing aids, the plurality of filtering units is configured to receive the magnitude of corresponding plurality of electrical input signals (e.g., a corresponding plurality of magnitude input signals). For example, the plurality of filtering units is configured to receive a corresponding plurality of magnitude vectors whose elements are absolute values. For example, each of the plurality of vectors is representative of an electrical input signal of the plurality of electrical input signals, such as time-domain signals (e.g., first electrical input signal, second input signal and/or third electrical input signal). For example, each of the plurality of vectors is representative of an electrical input signal of the plurality of electrical input signals, such as frequency domain signals (e.g., first frequency domain signal, a second frequency domain signal). Optionally, the plurality of filtering units is configured to receive a corresponding plurality of magnitude-squared signals (e.g., a plurality of vectors whose elements are absolute-squared values). In one or more example hearing aids, the plurality of filtering units is configured to provide a corresponding plurality of filtered electrical input signals. In one or more examples, the plurality of filtering units is configured to apply a LPF to the corresponding plurality of electrical input signals (e.g., to the corresponding plurality of magnitude input signals and/or magnitude-squared input signals) for provision of a corresponding plurality of filtered electrical input signals (e.g., a first filtered electrical input signal, a second filtered electrical input signal and/or a third filtered electrical input signal). In one or more example hearing aids, to determine the ultrasound processed signal is based on the plurality of filtered electrical input signals. In one or more example hearing aids, the plurality of filtering units is configured to provide the corresponding plurality of filtered electrical input signals before comparing the magnitudes associated with each of the plurality of electrical input signals (e.g., plurality of magnitude signals and/or plurality of magnitude-squared signals). In one or more example hearing aids, the ultrasound processing unit is configured to determine the ultrasound processed signal based on the plurality of filtered electrical input signals.

For example, a filtering unit can be implemented using a first order IIR LPF. For example, a first order IIR LPF can be given by mₗₚ(n)=(1−λ)*mₗₚ(n−1)+λ*m(n), where m(n) denotes a magnitude (e.g., or a magnitude-squared) estimate of the nth time frame (e.g., for a given frequency channel), mₗₚ(n) denotes a low-pass filtered magnitude estimate at the nth time frame, mₗₚ(n−1) denotes a low-pass filtered magnitude estimate at the (n−1)th time frame, and λ denotes a value controlling the amount of smoothing, e.g., taking values between 0 and 1 (e.g., with value 1 indicating no smoothing effect).

In one or more example hearing aids, a filtered electrical input signal can be seen as a magnitude signal and/or a magnitude-squared signal varying slowly, thereby exhibiting a slowly fluctuating selection decision. A filtered electrical input signal may be a filtered version of a frequency domain signal. A filtered electrical input signal may be a filtered version of a time-domain signal. Embodiments of the present disclosure may allow determination of an ultrasound reduced signal in a controlled manner, such as while avoiding rapidly fluctuating decisions.

For example, when the ultrasound detection unit determines that at least two of the plurality of electrical input signals comprise no or minor ultrasound artifacts, the hearing aid can be configured to apply hysteresis to the plurality of filtered electrical input signals, in turn avoiding rapidly fluctuating decisions. For example, applying hysteresis to the plurality of filtered electrical input signals comprises to, upon determining that the difference between the plurality of filtered electrical input signals is above a first threshold, enter an ultrasound mode. Entering an ultrasound mode may comprise enabling removal of the ultrasound. Enabling removal of the ultrasound may comprise selecting the ultrasound processed signal as the electrical input signal provided by the microphone of the plurality of microphones with the lowest sensitivity. Enabling removal of the ultrasound may comprise selecting the ultrasound processed signal as the electrical input signal of the plurality of electrical input signals comprising the lowest magnitude. Enabling removal of the ultrasound may comprise selecting the time-frequency bin comprising the lowest magnitude of each pair of time-frequency bins. For example, applying hysteresis to the plurality of filtered electrical input signals comprises to, upon determining that the difference between the plurality of filtered electrical input signals is below a second threshold, leaving the ultrasound mode (e.g., combining the at least two of the plurality of electrical input signal for directionality purposes). For example, the first threshold is greater than the second threshold.

For example, for a binaural hearing system (e.g., comprising a first and second hearing aid), entering an ultrasound mode can be a joint decision between both the first and second hearing aids. For example, the first and second hearing aids are configured to enter the ultrasound mode when at least one of the first and second hearing aids detects ultrasound. The at least one of the first and second hearing aids detecting ultrasound may transmit, to the other hearing aid of the first and second hearing aids a control message (e.g., a flag) indicating such detection of ultrasound. The control message may cause the other hearing aid to enter the ultrasound mode.

Optionally, ultrasound mode may only be entered when both the first and second hearing aids detects ultrasound. For example, the first and second hearing aids can exchange control messages with each other, the control messages being indicative of an ultrasound detection.

For example, when only one of the first and second hearing aids detects ultrasound, the ultrasound processed signal from the other hearing aid of the first and second hearing aids (e.g., signal that does not contain any ultrasound) can be transmitted (e.g., by the other hearing aid of the first and second hearing aids) to the one of the first and second hearing aids (e.g., contralateral hearing aid) and applied to the listener, un turn outputting a signal absent from ultrasound (e.g., such scenario may happen as ultrasound may be masked by the head shadow).

Optionally, the first frequency-domain signal can comprise at least a TF bin of the first plurality of TF bins not comprising ultrasound interference. The second frequency-domain signal may comprise at least a TF bin of the second plurality of TF bins not comprising ultrasound interference. In one or more example hearing aids, the beamforming unit is configured to receive a portion of the first frequency-domain signal that is not contaminated by ultrasound interference when a corresponding portion of the second frequency-domain signal is contaminated by ultrasound interference. In one or more example hearing aids, the beamforming unit is configured to receive both a portion of the second frequency-domain signal and a portion of the first frequency-domain signal when both portions are not contaminated or substantially contaminated by ultrasound interference. In one or more example hearing aids, the beamforming unit is configured to provide a beamformed frequency-domain signal by (e.g., linearly) combining the first frequency-domain signal with the second frequency-domain signal. The beamforming unit may enable attenuation of undesirable noise while maintaining the signal of interest. The beamformed frequency-domain signal may comprise a beamformed plurality of TF bins.

In one or more example hearing aids, the ultrasound processing unit is configured to receive the first frequency-domain signal, the second frequency-domain signal, and the beamformed frequency-domain signal when the ultrasound detection unit detects at least on TF bin comprising no ultrasound interference in both first frequency-domain signal and second frequency-domain signal. The ultrasound processing unit may be configured to determine (e.g., generate) the ultrasound processed signal by including the portion of the beamformed frequency-domain signal corresponding to the TF comprising no ultrasound interference in the matrix representative of the ultrasound processed signal. In other words, the TF bin comprising the lowest TF magnitude may be seen as a TF bin comprised in the beamformed frequency-domain signal. For example, a set of TF bins comprises a first TF bin of the first plurality of TF bins, a corresponding second TF bin of the second plurality of TF bins, and a corresponding third bin of the beamformed plurality of TF bins. For example, to determine the ultrasound processed signal comprises to select the TF bin comprising the lowest TF magnitude of each set of TF bins. The TF bin comprising the lowest TF magnitude may be a TF bin of the beamformed signal when no ultrasound artifacts are detected in the corresponding TF bin of the first frequency-domain signal and the second frequency-domain signal. The TF bin comprising the lowest TF magnitude may be a TF bin of the first frequency-domain signal when ultrasound artifacts are detected in the corresponding TF bin of the second frequency-domain signal and in the TF bin of the first frequency-domain signal, the ultrasound aliasing being more likely to be audible at the corresponding TF bin of the second frequency-domain signal. The TF bin comprising the lowest TF magnitude may be a TF bin of the second frequency-domain signal when ultrasound artifacts are detected in the corresponding TF bin of the first frequency-domain signal and in the TF bin of the second frequency-domain signal, the ultrasound aliasing being more likely to be audible at the corresponding TF bin of the first frequency-domain signal. In other words, a portion of the beamformed frequency-domain signal may be selected to generate the ultrasound processed signal when in absence of ultrasound. A portion of the frequency-domain signal containing the least ultrasound aliasing may be selected to generate the ultrasound processed signal when ultrasound is present and/or detected.

In one or more example hearing aids, the ultrasound processing unit is in communication with a synthesis filter bank configured to convert the ultrasound processed signal in the frequency domain into the time domain. For example, the output unit comprises a separate synthesis filter bank for each output transducer of a plurality of transducers. For example, the output unit comprises a synthesis filter bank for the output transducer included in the output unit.

In one or more example hearing aids, the ultrasound processing unit is in communication with a gain unit. In one or more example hearing aids, the gain unit is configured to provide a second ultrasound processed signal by applying a gain to the ultrasound processed signal. In one or more example hearing aids, the gain unit is configured to apply a gain to the ultrasound processed signal, the ultrasound processed signal being in the frequency domain. For example, the gain unit is configured to apply a narrow-band gain only located at the frequencies where ultrasound is occurring and/or likely to occur. For example, such gain adjustment can advantageously allow for a further reduction of the ultrasound interference in the ultrasound processed signal. Such gain adjustment may not alter the overall perception of loudness. In one or more example hearing aids, the gain unit is configured to apply a gain to the ultrasound processed signal, the ultrasound processed signal being in the time domain. In one or more example hearing aids, the output unit is configured to output the audible sound signal to the user wearing the hearing aid based on the second ultrasound processed signal.

In one or more example hearing aids, the hearing aid comprises a ‘forward’ (or ‘signal’) path configured to process an audio signal between an input and an output of the hearing aid. In one or more example hearing aids, the hearing aid comprises a signal processing unit configured to apply one or more processing algorithms to the plurality of electrical input signals, e.g., input signals of a forward path from the input to the output of the hearing aid. The signal processing unit may be located in the forward path. The one or more processing algorithms may e.g. comprise a compression algorithm configured to amplify (or attenuate) a signal according to the needs of the user, e.g. to compensate for a hearing impairment of the user. Other processing algorithms may include frequency transposition, feedback control, etc. For example, the signal processing unit is configured to provide a frequency dependent gain and/or a level dependent compression and/or a transposition (with or without frequency compression) of one or more frequency ranges to one or more other frequency ranges, e.g., to compensate for a hearing impairment of a user. The signal processing unit may be configured to enhance the plurality of electrical input signals and provide a processed output signal.

The hearing aid may comprise an ‘analysis’ path comprising functional components configured to analyze signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

In one or more example hearing aids, the hearing aid comprises a directional microphone system configured to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

Most sound signal sources (except the user's own voice) are located far away from the user compared to dimensions of the hearing aid, e.g. a distance d_{mic} between two microphones of a directional system. A typical microphone distance in a hearing aid is of the order 10 mm. A minimum distance of a sound source of interest to the user (e.g. sound from the user's mouth or sound from an audio delivery device) is of the order of 0.1 m (>10 d_{mic}). For such minimum distances, the hearing aid (e.g., microphones) would be in the acoustic near-field of the sound source and a difference in level of the sound signals impinging on respective microphones may be significant. A typical distance for a communication partner is more than 1 m (>100 d_{mic}). The hearing aid (e.g., microphones) would be in the acoustic far-field of the sound source and a difference in level of the sound signals impinging on respective microphones is insignificant. The difference in time of arrival of sound impinging in the direction of the microphone axis (e.g., the front or back of a normal hearing aid) is ΔT=d_{mic}/v_{sound}=0.01/343[s]=29 μs, where v_{sound} is the speed of sound in air at 20° C. (343 m/s).

In one or more example hearing aids, the hearing aid comprises antenna and transceiver circuitry allowing a wireless link to an entertainment device (e.g. a TV-set), a communication device (e.g. a telephone), a wireless microphone, a separate (external) processing device, or another hearing aid, etc. The hearing aid may be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

A wireless link established by antenna and transceiver circuitry of the hearing aid may be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra-Wideband (UWB) technology.

In one or more example hearing aids, the hearing aid can be constituted by or form part of a portable (e.g., configured to be wearable) device, such as a device comprising a local energy source, e.g., a battery (e.g. a rechargeable battery). The hearing aid may be a low weight, easily wearable, device, e.g., having a total weight less than 100 g, such as less than 20 g, such as less than 5 g.

The hearing aid may be configured to operate in different modes, e.g., a normal mode and one or more specific modes, e.g., selectable by a user, or automatically selectable. A mode of operation may be optimized to a specific acoustic situation or environment, e.g., a communication mode, such as a telephone mode. A mode of operation may include a low-power mode, where functionality of the hearing aid is reduced (e.g., to save power), e.g. to disable wireless communication, and/or to disable specific features of the hearing aid.

The hearing aid may comprise a number of detectors configured to provide status signals relating to a current physical environment of the hearing aid (e.g., the current acoustic environment), and/or to a current state of the user wearing the hearing aid, and/or to a current state or mode of operation of the hearing aid. Alternatively or additionally, one or more detectors may form part of an external device in communication (e.g., wirelessly) with the hearing aid. An external device may e.g. comprise another hearing aid, a remote control, and audio delivery device, a telephone (e.g., a smartphone), an external sensor, etc.

One or more of the number of detectors may operate on the full band signal (time domain). One or more of the number of detectors may operate on band split signals ((time-) frequency domain), e.g., in a limited number of frequency bands.

The number of detectors may comprise a level detector for estimating a current level of a signal of the forward path. The detector may be configured to decide whether the current level of a signal of the forward path is above or below a given (L-)threshold value. The level detector operates on the full band signal (time domain). The level detector operates on band split signals ((time-) frequency domain).

The hearing aid may comprise a voice activity detector (VAD) for estimating whether or not (or with what probability) an input signal comprises a voice signal (at a given point in time). A voice signal may in the present context be taken to include a speech signal from a human being. It may also include other forms of utterances generated by the human speech system (e.g., singing). The voice activity detector unit may be adapted to classify a current acoustic environment of the user as a VOICE or NO-VOICE environment. This has the advantage that time segments of the electric microphone signal comprising human utterances (e.g., speech) in the user's environment can be identified, and thus separated from time segments only (or mainly) comprising other sound sources (e.g., artificially generated noise). The voice activity detector may be adapted to detect as a VOICE also the user's own voice. Alternatively, the voice activity detector may be adapted to exclude a user's own voice from the detection of a VOICE.

The hearing aid may comprise an own voice detector for estimating whether or not (or with what probability) a given input sound (e.g., a voice, e.g. speech) originates from the voice of the user of the system. A microphone system of the hearing aid may be adapted to be able to differentiate between a user's own voice and another person's voice and possibly from NON-voice sounds.

The number of detectors may comprise a movement detector, e.g., an acceleration sensor. The movement detector may be configured to detect movement of the user's facial muscles and/or bones, e.g., due to speech or chewing (e.g., jaw movement) and to provide a detector signal indicative thereof.

The hearing aid may comprise a classification unit configured to classify the current situation based on input signals from (at least some of) the detectors, and possibly other inputs as well. In the present context ‘a current situation’ may be taken to be defined by one or more of
a) the physical environment (e.g., including the current electromagnetic environment, e.g. the occurrence of electromagnetic signals (e.g., comprising audio and/or control signals) intended or not intended for reception by the hearing aid, or other properties of the current environment than acoustic);
b) the current acoustic situation (e.g., input level, feedback, etc.), and
c) the current mode or state of the user (e.g., movement, temperature, cognitive load, etc.);
d) the current mode or state of the hearing aid (e.g., program selected, time elapsed since last user interaction, etc.) and/or of another device in communication with the hearing aid.

The classification unit may be based on or comprise a neural network, e.g. a recurrent neural network, e.g. a trained neural network.

In one or more example hearing aids, the hearing aid comprises an acoustic (and/or mechanical) feedback control (e.g., suppression) or an echo-cancelling system. For example, adaptive feedback cancellation allows tracking feedback path changes over time. It may be based on a linear time invariant filter to estimate the feedback path, with its filter weights being updated over time. The filter update may be calculated using stochastic gradient algorithms, such as a Least Mean Square (LMS) algorithm or a Normalized LMS (NLMS) algorithm. For example, such algorithms may enable minimization of the error signal in the mean square sense with the NLMS additionally normalizing the filter update with respect to the squared Euclidean norm of some reference signal.

In one or more example hearing aids, the hearing aid can further comprise other relevant functionality for the application in question, e.g. compression, noise reduction, etc. In one or more example hearing aids, the hearing aid comprises a hearing instrument, e.g., a hearing instrument adapted for being located at the ear or fully or partially in the ear canal of a user.

### Use

In an aspect, use of a hearing aid as described above, in the ‘detailed description of embodiments’ and in the claims, is moreover provided. Use may be provided in a system comprising one or more hearing aids (e.g. hearing instruments).

### A Method

A method of operating a hearing aid is disclosed. The method comprises providing, using a plurality of microphones, a corresponding plurality of electrical input signals representing a sound affected by an ultrasound in an environment of the hearing aid. The ultrasound being characterized by an ultrasound frequency. Each of the plurality of electrical input signals is provided in a digitized form. The plurality of microphones being configured to have different port diameters such that sensitivities towards the ultrasound frequency are different among the plurality of microphones. The method comprises determining, based on the different sensitivities towards the ultrasound frequency, an ultrasound processed signal. The method comprises outputting, based on the ultrasound processed signal, an audible signal to the user wearing the hearing aid.

It is intended that some or all of the structural features of the hearing aid described above, in the ‘detailed description of embodiments’ or in the claims can be combined with embodiments of the method, when appropriately substituted by a corresponding process and vice versa. Embodiments of the method have the same advantages as the corresponding hearing aid.

### A Computer Readable Medium or Data Carrier

In an aspect, a tangible computer-readable medium (a data carrier) storing a computer program comprising program code means (instructions) for causing a data processing system (a computer) to perform (carry out) at least some (such as a majority or all) of the (steps of the) method described above, in the ‘detailed description of embodiments’ and in the claims, when said computer program is executed on the data processing system is furthermore provided by the present application.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Other storage media include storage in DNA (e.g. in synthesized DNA strands). Combinations of the above should also be included within the scope of computer-readable media. In addition to being stored on a tangible medium, the computer program can also be transmitted via a transmission medium such as a wired or wireless link or a network, e.g. the Internet, and loaded into a data processing system for being executed at a location different from that of the tangible medium.

### A Computer Program

A computer program (product) comprising instructions which, when the program is executed by a computer, cause the computer to carry out (steps of) the method described above, in the ‘detailed description of embodiments’ and in the claims is furthermore provided by the present application.

### A Data Processing System

In an aspect, a data processing system comprising a processor and program code means for causing the processor to perform at least some (such as a majority or all) of the steps of the method described above, in the ‘detailed description of embodiments’ and in the claims is furthermore provided by the present application.

### A Hearing System

In a further aspect, a hearing system comprising a hearing aid as described above, in the ‘detailed description of embodiments’, and in the claims, and an auxiliary device is moreover provided.

The hearing system may be adapted to establish a communication link between the hearing aid and the auxiliary device to provide that information (e.g., control and status signals, possibly audio signals) can be exchanged or forwarded from one to the other. The hearing system may be configured to perform the processing, e.g. ultrasound reduction, according to the present disclosure, fully or partially in a separate audio processing device.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g., from an entertainment device, e.g. a TV or a music player, a telephone apparatus, e.g. a mobile telephone or a computer, e.g., a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g., a binaural hearing aid system. For example, an input unit comprising a plurality of microphones of each of the two hearing aids is configured to provide a corresponding plurality of electrical input signals representing a sound affected by an ultrasound in an environment of the respective hearing aid. The ultrasound is characterized by an ultrasound frequency. Each of the plurality of electrical input signals is provided in a digitized form, and the plurality of microphones being configured to have different sensitivities towards the ultrasound frequency.

For example, an ultrasound processing unit of each of the two hearing aids is configured to receive the respective plurality of electrical input signals. For example, the ultrasound processing unit of each of the two hearing aids is configured to determine, based on the different sensitivities towards the ultrasound frequency, a respective ultrasound processed signal. For example, an output unit of each of the two hearing aids is configured to output, based on the ultrasound processed signal, a respective audible signal to the user wearing the hearing aid. Optionally, one of the two hearing aids can be configured to determine an ultrasound processed signal, and transmit said of each of the two hearing aids to other hearing aid of the two hearing aids.

For example, the two hearing aids can be configured to enter the ultrasound mode when at least one of the first and second hearing aids detects ultrasound. The at least one of the two hearing aids detecting ultrasound may transmit, to the other hearing aid of the two hearing aids a control message (e.g., a flag) indicating such detection of ultrasound. The control message may cause the other hearing aid to enter the ultrasound mode. Optionally, ultrasound mode may only be entered when the two hearing aids detects ultrasound. For example, the two hearing aids can exchange control messages with each other, the control messages being indicative of an ultrasound detection. For example, when only one of the two hearing aids detects ultrasound, the ultrasound processed signal from the other hearing aid (e.g., signal that does not contain any ultrasound) can be transmitted (e.g., by the other hearing aid) to the one of the two hearing aids (e.g., contralateral hearing aid) and applied to the listener, un turn outputting a signal absent from ultrasound (e.g., such scenario may happen as ultrasound may be masked by the head shadow).

### An App

In a further aspect, a non-transitory application, termed an APP, is furthermore provided by the present disclosure. The APP comprises executable instructions configured to be executed on an auxiliary device to implement a user interface for a hearing aid or a hearing system described above in the ‘detailed description of embodiments’, and in the claims. The APP may be configured to run on cellular phone, e.g., a smartphone, or on another portable device allowing communication with said hearing aid or said hearing system.

### Definitions

In the present context, a hearing aid, e.g., a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g., be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g., as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal. The hearing aid may comprise a single unit or several units communicating (e.g., acoustically, electrically or optically) with each other. The loudspeaker may be arranged in a housing together with other components of the hearing aid, or may be an external unit in itself (possibly in combination with a flexible guiding element, e.g., a dome-like element).

A hearing aid may be adapted to a particular user's needs, e.g., a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g., adapted to speech). The frequency and level dependent gain may e.g., be embodied in processing parameters, e.g. uploaded to the hearing aid via an interface to a programming device (fitting system), and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g., a music player, a wireless communication device, e.g., a mobile phone (such as, a smartphone) or a tablet or another device, e.g., comprising a graphical interface. Hearing aids, hearing systems or binaural hearing systems may e.g., be used for compensating for a hearing-impaired person's loss of hearing capability, augmenting or protecting a normal-hearing person's hearing capability and/or conveying electronic audio signals to a person. Hearing aids or hearing systems may e.g., form part of or interact with public-address systems, active ear protection systems, handsfree telephone systems, car audio systems, entertainment (e.g., TV, music playing or karaoke) systems, teleconferencing systems, classroom amplification systems, etc.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIGS. 1A-1B illustrate example response curves of a plurality of microphones according to the present disclosure,

FIG. 2 schematically illustrates an example first hearing aid according to the present disclosure,

FIG. 3 schematically illustrates an example second hearing aid according to the present disclosure,

FIGS. 4A-4B schematically illustrate an example third hearing aid according to the present disclosure, and

FIG. 5 illustrates a flow-chart of an example method according to the present disclosure. The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

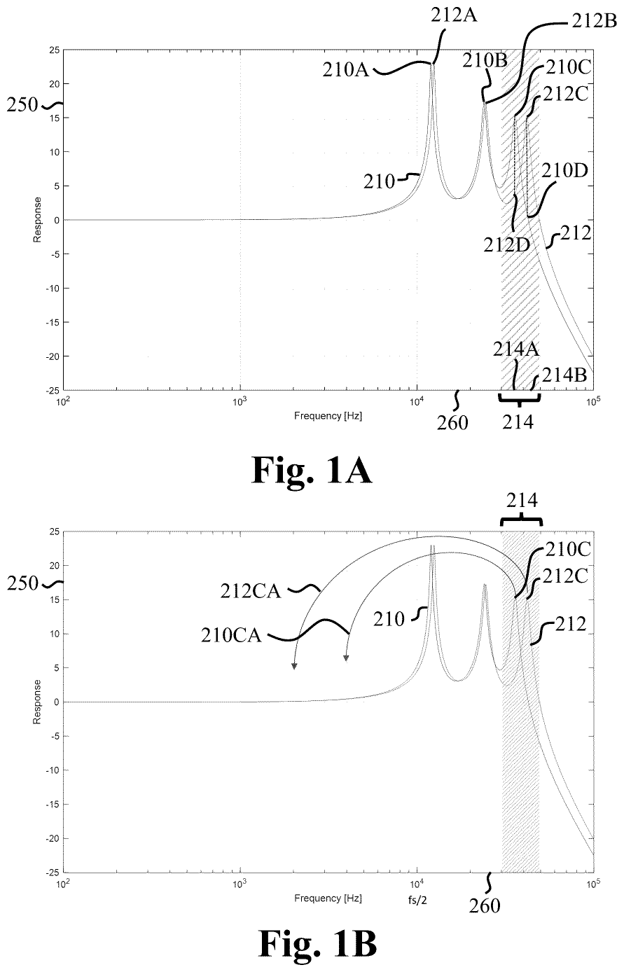

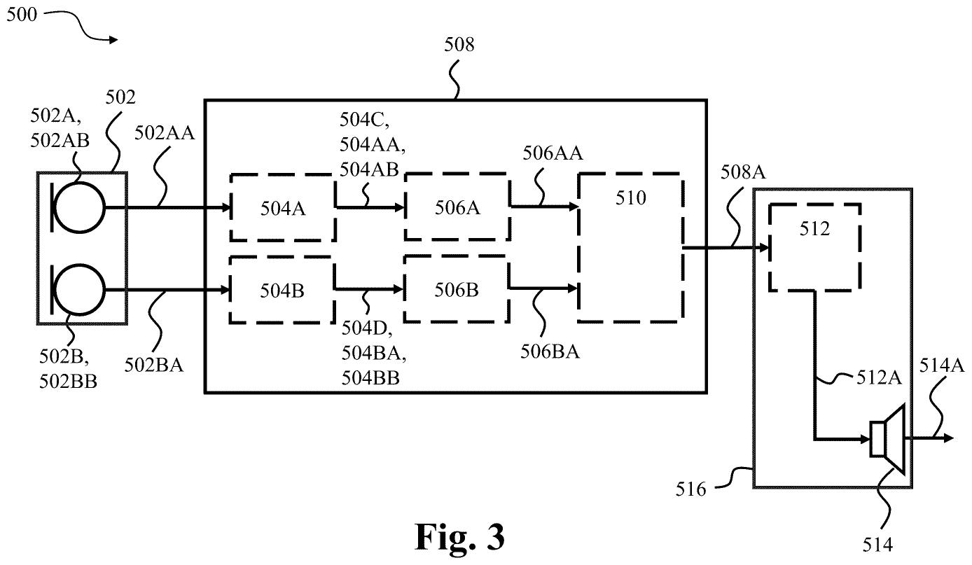

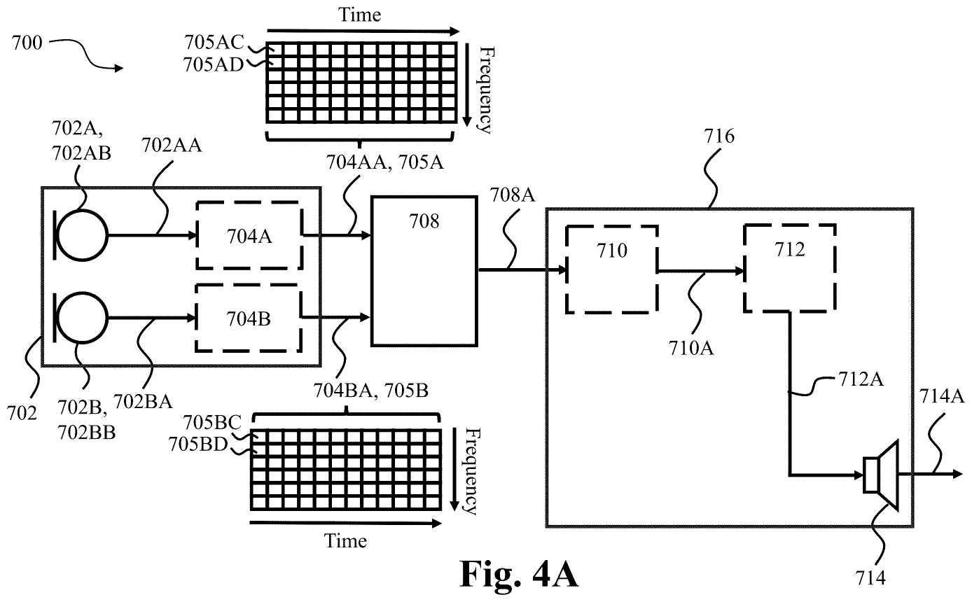

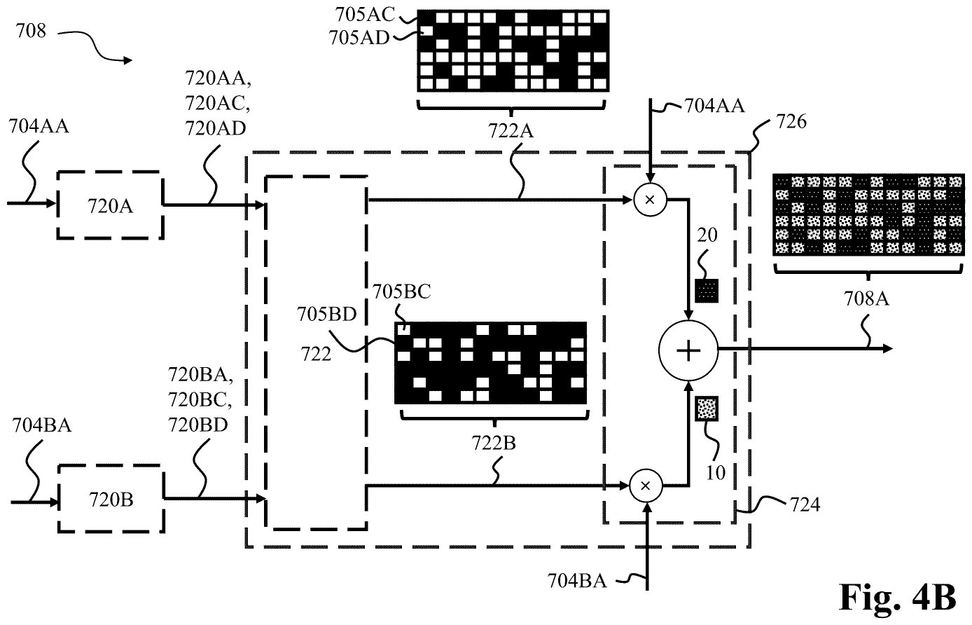

FIGS. 1A-1B illustrate example response curves 210, 212 of a plurality of microphones (e.g., plurality of microphones 302A, 302B of FIG. 1, plurality of microphones 502A, 502B of FIG. 3, and/or plurality of microphones 702A, 702B of FIGS. 4A-4B) according to the present disclosure. Horizontal axis 260 illustrates a frequency range in Hertz (Hz). Vertical axis 250 illustrates a frequency response of each microphone of the plurality of microphones in decibels (dB). In other words, the frequency response of each microphone may show a plurality of sensitivities towards a corresponding plurality of ultrasound frequencies.

The plurality of microphones is configured to provide a corresponding plurality of electrical input signals representing a sound affected by an ultrasound (e.g., an ultrasonic sound) in an environment of a hearing aid comprising the plurality of microphones. Each of the plurality of electrical input signals may comprise an ultrasonic component. The ultrasound being characterized by an ultrasound frequency. Each of the plurality of electrical input signals is provided in a digitized form, e.g., a digitally sampled signal.

Aliasing may occur when sampling each of the plurality of electrical input signal (e.g., at a sampling rate of 20 kHz). In other words, aliasing may occur during the AD conversion process. Frequencies that are greater than half of the sampling rate may enter the AD conversion process as aliasing artifacts. For example, due to aliasing, the ultrasonic component that is present in each of the plurality of electrical input signals may be mapped to an audible frequency range as a spatial aliasing artifact, such as spatial aliasing artifact 210CA, 212CA of FIG. 1B.

The plurality of microphones is configured to have different sensitivities towards the (e.g., same) ultrasound frequency. For example, a sensitivity towards an ultrasound frequency may be construed as a resonance frequency in the ultrasound range which is mapped to an audible frequency range as a spatial aliasing artifact. For example, the shaded area 214 indicates the frequency range where the ultrasound is likely to occur. For example, the plurality of microphones may be configured to have different resonance frequencies, especially at the frequency range where ultrasound is likely to occur.

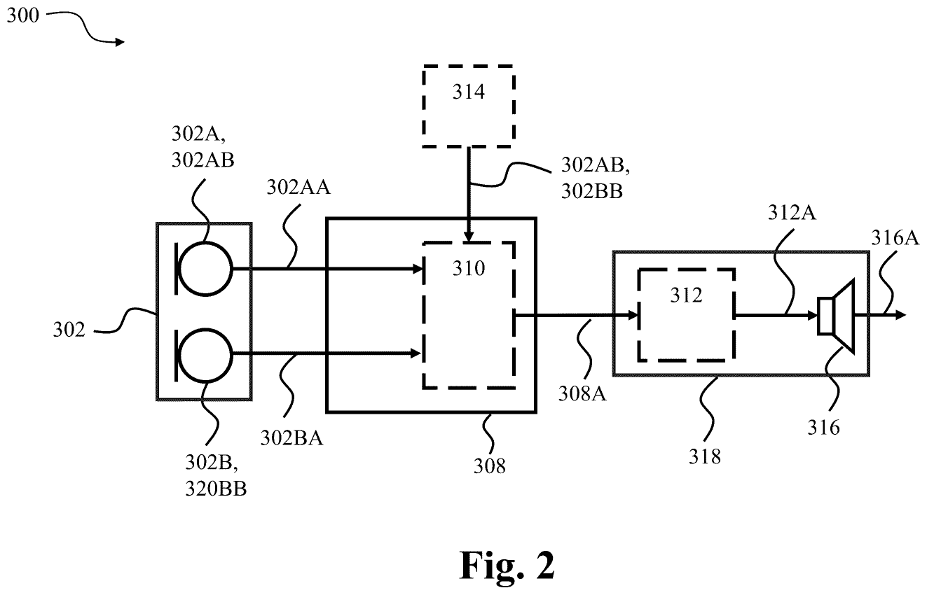

FIGS. 2A-2B shows a first frequency response 210 of a first microphone of the plurality of microphones and a second frequency response 212 of a second microphone of the plurality of microphones.

For example, the first frequency response 210 has resonance frequencies 210A, 210B, 210C. For example, the first microphone is configured to have a plurality of sensitivities (e.g., indicative of the resonance frequencies 210A, 210B, 210C) towards a corresponding plurality of ultrasound frequencies. For example, the second frequency response 212 has resonance frequencies 212A, 212B, 212C. For example, the second microphone is configured to have a plurality of sensitivities (e.g., indicative of the resonance frequencies 212A, 212B, 212C) towards a corresponding plurality of ultrasound frequencies. For example, the ultrasound in the environment of the hearing aid can be characterized by an ultrasound frequency included in the frequency range where the ultrasound is likely to occur, such as in the shaded area 214.

For example, the ultrasound in the environment of the hearing aid is characterized by a first ultrasound frequency 214A. For example, the first microphone is configured to have a first primary sensitivity towards the first ultrasound frequency 214A. The first primary sensitivity may be seen as the resonance frequency 210C, such resonance frequency being located in the frequency range where the ultrasound is likely to occur, e.g., such resonance frequency being co-located with the first ultrasound frequency 214A. For example, the second microphone is configured to have a second primary sensitivity towards the first ultrasound frequency 214A. The second primary sensitivity may be illustrated by point 212D of frequency response 212. For example, point 212D of frequency response 212 can be seen as the sensitivity of frequency response 212, at the frequency, where the frequency response 210 has a resonance frequency (such as, resonance frequency 210C). For example, the frequency response 210 has its highest sensitivities at the resonance frequencies 210A, 210B, 210C. For example, the first microphone is the microphone having the highest sensitivity towards the first ultrasound frequency 214A when the resonance frequency 210C is (e.g., approximately) co-located with the first ultrasound frequency 214A.

For example, the ultrasound in the environment of the hearing aid is characterized by a second ultrasound frequency 214B. For example, the second microphone is configured to have a second secondary sensitivity towards the second ultrasound frequency 214B. The second secondary sensitivity may be seen as the resonance frequency 212C, such resonance frequency being located in the frequency range where the ultrasound is likely to occur, e.g., such resonance frequency being co-located with the first ultrasound frequency 214B. For example, the first microphone is configured to have a first secondary sensitivity towards the second ultrasound frequency 214B. The second primary sensitivity may be illustrated by point 210D of frequency response 210. For example, point 210D can be seen as the sensitivity of frequency response 210, at the frequency, where the frequency response 212 has a resonance frequency (such as, resonance frequency 212C). For example, the frequency response 212 has its highest sensitivities at the resonance frequencies 212A, 212B, 212C. For example, the second microphone is the microphone having the highest sensitivity towards the second ultrasound frequency 214B when the resonance frequency 212C is (e.g., approximately) co-located with the second ultrasound frequency 214B.

For example, the first microphone has the same sensitivity as the second microphone when the first frequency response 210 coincides with the second resonance frequency 212. In other words, there may be frequency bands where the first microphone and the second microphone have a similar sensitivity. Nonetheless, the first microphone and the second microphone may have different sensitivities towards the same ultrasound frequency, with such sensitivities indicative of respective resonance frequencies 210C, 212C. Optionally, the first microphone and the second microphone may have different sensitivities towards the same ultrasound frequency, such as different resonance frequencies in the signal range where ultrasound is likely to occur should.

Due to the different sensitivities (e.g., resonance frequencies) towards the ultrasound frequency, an ultrasound component occurring in a given frequency of the frequency range illustrated by the shaded area 214 may become more audible at one microphone compared to the other microphone. For example, a microphone of the plurality of microphones having the highest sensitivity towards the ultrasound frequency is a microphone configured to provide an electrical input signal which is the most contaminated and/or polluted by such ultrasound (e.g., an electrical input signal experiencing the strongest ultrasound interference), thereby being audible to the user wearing the hearing aid.

FIG. 2 schematically illustrates an example first hearing aid 300 according to the present disclosure. The first hearing aid 300 comprises an input unit 302, an ultrasound processing unit 308, and an output unit 318. The input unit 302 comprises a plurality of microphones 302A, 302B. In one or more example hearing aids, the ultrasound processing unit 308 comprises a comparison and selection unit 310. In one or more example hearing aids, the output unit 318 comprises a gain unit 312 and/or an output transducer 316. In one or more example hearing aids, the first hearing aid 300 comprises a memory 314.

The input unit 302 comprising the plurality of microphones 302A, 302B is configured to provide a corresponding plurality of electrical input signals 302AA, 302BA representing a sound affected by an ultrasound in an environment of the first hearing aid 300. The ultrasound is characterized by an ultrasound frequency. Each of the plurality of electrical input signals 302AA, 302BA is provided in a digitized form. The plurality of microphones 302A, 302B is configured to have different sensitivities towards the ultrasound frequency (e.g., the same ultrasound frequency).

In other words, the input unit 302 may comprise a first microphone 302A and a second microphone 302B. The first microphone 302A may be configured to provide a first electrical input signal 302AA. The first microphone 302A may be configured to have a first sensitivity 302AB towards the ultrasound frequency. The second microphone 302B may be configured to provide a second input signal 302BA. The second microphone 302B may be configured to have a second sensitivity 302BB towards the ultrasound frequency. The first sensitivity 302AB may be different from the second sensitivity 302BB. The memory 314 may be configured to store the first sensitivity 302AB and the second sensitivity 302BB.

The ultrasound processing unit 308 is in communication with the input unit 302. The ultrasound processing unit 308 is configured to receive the plurality of electrical input signals 302AA, 302BA. The ultrasound processing unit 308 is configured to determine, based on the different sensitivities towards the ultrasound frequency, the ultrasound processed signal 308A.

In other words, the ultrasound processing unit 308 may be configured to receive the first electrical input signal 302AA and the second input signal 302BA. The ultrasound processing unit 308 may be configured to determine the ultrasound processed signal 308A based on the first input signal 302AA and the second input signal 302BA. The ultrasound processing unit 308 may be configured to determine the ultrasound processed signal 308A based on the first sensitivity 302AB and the second sensitivity 302BB. The ultrasound processing unit 308 may be configured to determine the ultrasound processed signal 308A based on the first input signal 302AA, the second input signal 302BA, the first sensitivity 302AB, and the second sensitivity 302BB.

In one or more example hearing aids, each of the plurality of electrical input signals 302AA, 302BA is a time-domain signal. For example, the first electrical input signals 302AA is a time-domain signal. For example, the second electrical input signals 302BA is a time-domain signal. The ultrasound processing unit 308 may be a time-domain ultrasound processing unit.

In one or more example hearing aids, each of the plurality of electrical input signals 302AA, 302BA is a frequency-domain signal. For example, the first electrical input signals 302AA is a frequency-domain signal. For example, the second electrical input signals 302BA is a frequency-domain signal. The ultrasound processing unit 308 may be a frequency-domain ultrasound processing unit.

In one or more example hearing aids, the comparison and selection unit 310 is configured to receive the plurality of electrical input signals 302AA, 302BA. In one or more example hearing aids, the comparison and selection unit 310 is configured to retrieve the sensitivity associated with each of the plurality of microphones 302A, 302B from the memory 314. In one or more example hearing aids, the comparison and selection unit 310 is configured to compare the sensitivity associated with each of the plurality of microphones 302A, 302B. For example, the comparison and selection unit 310 is configured to compare the first sensitivity 302AB of the first microphone 302A with the second sensitivity 302BB of the second microphone 302B.

In one or more example hearing aids, the comparison and selection unit 310C is configured to determine to select, based on the comparison, the ultrasound processed signal 308A as the electrical input signal provided by the microphone of the plurality of microphones 302A, 302B with the lowest sensitivity. For example, the comparison and selection unit 310 is configured to select the ultrasound processed signal 308A as the first electrical input signal 302A when the first sensitivity 302AB of the first microphone 302A is lower than the second sensitivity 302BB of the second microphone 302B. For example, the ultrasound processed signal 308A is the first electrical input signal 302A. For example, the comparison and selection unit 310 is configured to determine to select the ultrasound processed signal 308A as the second electrical input signal 302B when the second sensitivity 302BB of the second microphone 302B is lower than the first sensitivity 302AB of the first microphone 302A. For example, the ultrasound processed signal 308A is the second electrical input signal 302B. In one or more example hearing aids, the ultrasound processed signal 308A can be seen as an ultrasound reduced signal.

The output unit 318 is configured to output, based on the ultrasound processed signal 308A, an audible signal 316A to the user wearing the first hearing aid 300. Optionally, the ultrasound processing unit 308 is in communication with the gain unit 312. In one or more example hearing aids, the gain unit 312 is configured to provide a second ultrasound processed signal 312A by applying a gain to the ultrasound processed signal 308A. For example, the gain unit 312 can be configured to either amplify or attenuate the ultrasound processed signal 308A when the plurality of electrical input signals 302AA, 302BA are time-domain signals (e.g., to change the overall loudness). For example, the gain unit 312 can be configured to further reduce ultrasound interference in the ultrasound processed signal 308A when the plurality of electrical input signals 302AA, 302BA are frequency-domain signals. For example, the second ultrasound processed signal 308A can be seen as a further ultrasound reduced signal. The output unit 318 may be configured to output the audible sound signal 316A to the user wearing the first hearing aid 300 based on the second ultrasound processed signal 312A.

FIG. 3 schematically illustrates an example second hearing aid 500 according to the present disclosure. The second hearing aid 500 comprises an input unit 502, an ultrasound processing unit 508, and an output unit 516. The input unit 502 comprises a plurality of microphones 502A, 502B. In one or more example hearing aids, the ultrasound processing unit 508 comprises one or more of: a plurality of magnitude determination units 504A, 504B, a plurality of filtering units 506A, 506B, and a comparison and selection unit 510. In one or more example hearing aids, the output unit 516 comprises a gain unit 512 and/or an output transducer 514. In one or more example hearing aids, the second hearing aid 500 comprises a memory (e.g., memory 314 of FIG. 1).

The input unit 502 comprises the plurality of microphones 502A, 502B configured to provide a corresponding plurality of electrical input signals 502AA, 502BA representing a sound affected by an ultrasound in an environment of the second hearing aid 500. The ultrasound is characterized by an ultrasound frequency. Each of the plurality of electrical input signals 502AA, 502BA is provided in a digitized form. The plurality of microphones 502A, 502B is configured to have different sensitivities towards the ultrasound frequency (e.g., the same ultrasound frequency).

In other words, the input unit 502 may comprise a first microphone 502A and a second microphone 502B. The first microphone 502A may be configured to provide a first electrical input signal 502AA. The first microphone 502A may be configured to have a first sensitivity 502AB towards the ultrasound frequency. The second microphone 502B may be configured to provide a second input signal 502BA. The second microphone 502B may be configured to have a second sensitivity 502BB towards the ultrasound frequency. The first sensitivity 502AB may be different from the second sensitivity 502BB.

The ultrasound processing unit 508 is in communication with the input unit 502. The ultrasound processing unit 508 is configured to receive the plurality of electrical input signals 502AA, 502BA. The ultrasound processing unit 508 is configured to determine, based on the different sensitivities towards the ultrasound frequency, the ultrasound processed signal 508A.

In other words, the ultrasound processing unit 508 may be configured to receive the first electrical input signal 502AA and the second input signal 502BA. The ultrasound processing unit 508 may be configured to determine the ultrasound processed signal 508A based on the first electrical input signal 502AA and the second electrical input signal 502BA. The ultrasound processing unit 508 may be configured to determine the ultrasound processed signal 508A based on the first electrical input signal 502AA, the second electrical input signal 502BA, the first sensitivity 502AB, and the second sensitivity 502BB.

In one or more example hearing aids, each of the plurality of electrical input signals 502AA, 502BA is a time-domain signal. For example, the first electrical input signals 502AA is a time-domain signal. For example, the second electrical input signals 502BA is a time-domain signal. The ultrasound processing unit 308 may be a time-domain ultrasound processing unit.

In one or more example hearing aids, the plurality of magnitude determination units 504A, 504B is configured to receive the corresponding plurality of electrical input signals 502AA, 502BA. In one or more example hearing aids, the plurality of magnitude determination units 504A, 504B is configured to determine (e.g., and provide) the magnitude associated with the corresponding plurality of electrical input signal 502AA, 502BA, such as a corresponding plurality of magnitudes 504AAA, 504BAA respectively.

For example, the ultrasound processing unit 508 comprises a first magnitude determination unit 504A and a second magnitude determination unit 504B. For example, the first magnitude determination unit 504A is configured to determine the magnitude of the first electrical input signal 502A, such as to determine a first magnitude 504AA. For example, the first magnitude determination unit 504A is configured to provide a first magnitude input signal 504C indicative of the first magnitude 504AA (e.g., a single value). The first magnitude 504AA may be seen as an absolute value and/or an absolute-squared value. For example, the first magnitude determination unit 504A is configured to determine the magnitude of the first electrical input signal 502A, such as to determine a plurality of first magnitudes 504AB. For example, the first magnitude determination unit 504A is configured to provide the first magnitude input signal 504C comprising the plurality of first magnitudes 504AB. The plurality of first magnitudes 504AB may be seen as a plurality of absolute values and/or a plurality of absolute-squared values.

For example, the second magnitude determination unit 504B is configured to determine the magnitude of the second electrical input signal 502B, such as to determine a second magnitude 504BA. For example, the first magnitude determination unit 504B is configured to provide a second magnitude input signal 504D indicative of the second magnitude 504BA (e.g., a single value). The second magnitude 504BA may be seen as an absolute value and/or an absolute-squared value. For example, the second magnitude determination unit 504B is configured to determine the magnitude of the second electrical input signal 502B, such as to determine a plurality of second magnitudes 504BB. For example, the second magnitude determination unit 504B is configured to provide the second magnitude input signal 504D comprising the plurality of second magnitudes 504BB. The plurality of second magnitudes 504BB may be seen as a plurality of absolute values and/or a plurality of absolute-squared values.

In one or more example hearing aids, the plurality of filtering units 506A, 506B is configured to receive the corresponding plurality of electrical input signals 502AA, 502BA. In one or more example hearing aids, the plurality of filtering units 506A, 506B is configured to provide a corresponding plurality of filtered electrical input signals 506AA, 506BA. In one or more example hearing aids, the ultrasound processing unit 508 can determine the ultrasound processed signal 508A based on the plurality of filtered electrical input signals 506AA, 506BA.

For example, the ultrasound processing unit 508 comprises a first filtering unit 506A configured to receive the first magnitude input signal 504C. For example, the first filtering unit 506A is configured to provide a first filtered electrical input signal 506AA. For example, the ultrasound processing unit 508 comprises a second filtering unit 506B configured to receive the second magnitude input signal 504D. For example, the second filtering unit 506B is configured to provide a second filtered electrical input signal 506BA. In one or more example hearing aids, the first filtered electrical input signal 506AA and the second filtered electrical input signal 506BA can be seen as magnitude input signals (e.g., filtered magnitude input signals).

In one or more example hearing aids, the comparison and selection unit 510 is configured to receive the plurality of filtered electrical input signals 506AA, 506BA. In one or more example hearing aids, the comparison and selection unit 510 is configured to compare the plurality of filtered electrical input signals 506AA, 506BA with one another. In other words, the comparison and selection unit 510 is configured to compare the magnitude associated with each of the plurality of electrical input signals 504A, 504B. For example, the comparison and selection unit 510 is configured to compare a filtered version of the first magnitude 504AA (e.g., or the first magnitude 504AA) with a filtered version of the second magnitude 504BA (e.g., or the second magnitude 504AA). For example, the comparison and selection unit 510 is configured to compare a filtered version of the plurality of first magnitudes 504AB (e.g., or the plurality of first magnitudes 504AB) with a corresponding filtered version of the plurality of second magnitudes 504BB (e.g., or the plurality of second magnitudes 504BB).

In one or more example hearing aids, the comparison and selection unit 510 is configured to select, based on the comparison, the ultrasound processed signal 510A as the electrical input signal of the plurality of electrical input signals 502AA, 502BA comprising the lowest filtered magnitude (e.g., a filtered version of magnitude). Optionally, the comparison and selection unit 510 can be configured to select, based on the comparison, the ultrasound processed signal 510A as the electrical input signal of the plurality of electrical input signals 502AA, 502BA comprising the lowest magnitude.

For example, the comparison and selection unit 510 is configured to select the ultrasound processed signal 508A as the first electrical input signal 502AA when the filtered version of the first magnitude 504AA (e.g., or of the plurality of first magnitudes 504AB) is lower than the filtered version of the second magnitude 504BA (e.g., or of the plurality of first magnitudes 504BB). For example, the first electrical input signal 502AA is the electrical input signal of the plurality of electrical input signals 502AA, 502BA the least contaminated by the ultrasound in the environment of the second hearing aid (e.g., least affected by ultrasound interference).

For example, the comparison and selection unit 510 is configured to select the ultrasound processed signal 508A as the second electrical input signal 502BA when the filtered version of the second magnitude 504BA (e.g., or of the plurality of second magnitudes 504BB) is lower than the filtered version of the first magnitude 504AA (e.g., or of the plurality of first magnitudes 504AB). For example, the second electrical input signal 502BA is the electrical input signal of the plurality of electrical input signals 502AA, 502BA the least contaminated by the ultrasound in the environment of the second hearing aid (e.g., least affected by ultrasound interference).

In one or more example hearing aids, the ultrasound processed signal 308A can be seen as an ultrasound reduced signal.

The output unit 516 is configured to output, based on the ultrasound processed signal 508A, an audible signal 514A to the user wearing the second hearing aid 500. Optionally, the ultrasound processing unit 308 is in communication with the gain unit 512. In one or more example hearing aids, the gain unit 512 is configured to provide a second ultrasound processed signal 512A by applying a gain to the ultrasound processed signal 508A. For example, the gain unit 512 can be configured to either amplify or attenuate the ultrasound processed signal 508A when the plurality of electrical input signals 502AA, 502BA are time-domain signals (e.g., to change the overall loudness). For example, the gain unit 512 can be configured to further reduce ultrasound interference in the ultrasound processed signal 508A when the plurality of electrical input signals 502AA, 502BA are frequency-domain signals. For example, the second ultrasound processed signal 508A can be seen as a further ultrasound reduced signal. The output unit 516 may be configured to output the audible sound signal 512A to the user wearing the second hearing aid 500 based on the second ultrasound processed signal 512A.

FIGS. 4A-4B schematically illustrates an example third hearing aid 700 according to the present disclosure. The third hearing aid 700 comprises an input unit 702, an ultrasound processing unit 708, and an output unit 716. The input unit 702 comprises a plurality of microphones 702A, 702B. In one or more example hearing aids, the input unit 702 comprises one or more of: the plurality of microphones 702A, 702B and a plurality of TF conversion units 704A, 704B. In one or more example hearing aids, the output unit 716 comprises one or more of: a gain unit 710, a synthesis filter bank 712, and an output transducer 714.

The input unit 702 comprises a plurality of microphones 702A, 702B configured to provide a corresponding plurality of first electrical input signals 702AA, 702BA representing a sound affected by an ultrasound in an environment of the third hearing aid 700. The ultrasound is characterized by an ultrasound frequency. Each of the plurality of first electrical input signals 702AA, 702BA is provided in a digitized form. The plurality of microphones 702A, 702B is configured to have different sensitivities towards the ultrasound frequency (e.g., the same ultrasound frequency).

In other words, the input unit 702 may comprise a first microphone 702A and a second microphone 702B. The first microphone 702A may be configured to provide a first primary electrical input signal 702AA. The first microphone 702A may be configured to have a first sensitivity 702AB towards the ultrasound frequency. The second microphone 702B may be configured to provide a first secondary input signal 702BA. The second microphone 702B may be configured to have a second sensitivity 702BB towards the ultrasound frequency. The first sensitivity 702AB may be different from the second sensitivity 702BB.

In one or more example hearing aids, the plurality of TF conversion units 704A, 704B (e.g., a plurality of analysis filters banks) configured to provide a corresponding plurality of frequency-domain signals 704AA, 704BA in a TF representation. In other words, the plurality of TF conversion units 704A, 704B may be configured to provide a corresponding plurality of second electrical input signals, such as the corresponding plurality of frequency-domain signals 704AA, 704BA in a TF representation. For example, the input unit 702 comprises a first analysis filter bank 704A configured to provide a first frequency-domain signal 704AA in a TF representation. For example, the input unit 702 comprises a second analysis filter bank 704B configured to provide a second frequency-domain signal 704BA in a TF representation.

In one or more example hearing aids, the first frequency-domain signal 704AA has a first plurality of TF bins 705A (e.g., a first TF grid). In one or more example hearing aids, the second frequency-domain signal 704BA has a second plurality of TF bins 705B (e.g., a second TF grid). In one or more example hearing aids, a pair of TF bins comprises a first TF bin of the first plurality of TF bins 705A (e.g., a first primary TF bin 705AC) and a corresponding second TF bin of the second plurality of TF bins 705B (e.g., a second primary TF bin 705BC).

The ultrasound processing unit 708 is in communication with the input unit 702. The ultrasound processing unit 708 is configured to receive the plurality of frequency-domain signals 704AA, 704BA. The ultrasound processing unit 708 is configured to determine, based on the different sensitivities towards the ultrasound frequency, the ultrasound processed signal 708A. The ultrasound processing unit 308 may be a frequency-domain ultrasound processing unit.

In other words, the ultrasound processing unit 708 may be configured to receive the first frequency-domain signal 704AA and the second frequency-domain signal 704BA. The ultrasound processing unit 708 may be configured to determine the ultrasound processed signal 708A based on the first frequency-domain signal 704AA and the second frequency-domain signal 704BA. The ultrasound processing unit 708 may be configured to determine the ultrasound processed signal 708A based on the first frequency-domain signal 704AA, the second frequency-domain signal 704BA, the first sensitivity 702AB, and the second sensitivity 702BB.

In one or more example hearing aids, the ultrasound processing unit 708 is in communication with the gain unit 710. In one or more example hearing aids, the gain unit 710 is configured to provide a second ultrasound processed signal 710A by applying a gain to the ultrasound processed signal 708A. For example, the gain unit 710 can be configured to further reduce ultrasound interference in the ultrasound processed signal 708A. For example, the second ultrasound processed signal 710A can be seen as a further ultrasound reduced signal.

In one or more example hearing aids, the ultrasound processing unit 708 is in communication with the synthesis filter bank 712. For example, the synthesis filter bank 712 is in communication with the gain unit 710. In one or more example hearing aids, the synthesis filter bank 712 is configured to convert the second ultrasound processed signal 710A in the frequency domain into a second ultrasound processed signal 712A (e.g., in the time domain).

The output unit 716 is configured to output, based on the ultrasound processed signal 708A, an audible signal 714A to the user wearing the third hearing aid 700. For example, the output unit 716 comprises the synthesis filter bank 712 in communication with the output transducer 714. Optionally, the output unit 716 is configured to output the audible sound signal 714A to the user wearing the third hearing aid 700 based on the second ultrasound processed signal 712A.

FIG. 4B schematically illustrates the ultrasound processing unit 708 of FIG. 4A. In one or more example hearing aids, the ultrasound processing unit 708 comprises one or more of: a plurality of magnitude determination units 720A, 720B, and a selection combining unit 726. For example, the selection combining unit 726 comprises a comparison and selection unit 722 and a generation unit 724.

In one or more example hearing aids, the plurality of magnitude determination units 720A, 720B is configured to receive the plurality of frequency-domain signals 704AA, 704BA. For example, a first magnitude determination unit 720A is configured to receive the first frequency-domain signal 704AA, the first frequency-domain signal 704AA having the first plurality of TF bins 705A. For example, the first plurality of TF bins 705A comprises a first primary TF bin 705AC, a first secondary TF bin 705AD, etc. For example, the second magnitude determination unit 720B is configured to receive the second frequency-domain signal 704AB, the second frequency-domain signal 704BA having the second plurality of TF bins 705B. For example, the second plurality of TF bins 705B comprises a second primary TF bin 705BC, a second secondary TF bin 705BD, etc.

For example, the first primary TF bin 705AC and the second primary TF bin 705BC form a first pair of TF bins. For example, the first primary TF bin 705AC is associated with a first primary frequency band and a first primary time instance. For example, the first primary TF bin 705AC can be construed as a first primary portion (e.g., a part) of the first frequency-domain signal 704AA (e.g., of the first electrical input signal 702AA), such portion being associated with the first primary frequency band and the first primary time instance. For example, the second primary TF bin 705BC is associated with a second primary frequency band and a second primary time instance. For example, the second primary TF bin 705BC can be construed as a second primary portion (e.g., a part) of the second frequency-domain signal 704BA (e.g., of the second electrical input signal 702BA), such portion being associated with the second primary frequency band and the second primary time instance. The first primary frequency band may be the same as the second primary frequency band. The first primary time instance may be the same as the second primary time instance. For example, the first primary TF bin 705AC and the second primary TF bin 705BC share the same location (e.g., position) in the first plurality of TF bins 705A and second plurality of TF bins 705B respectively.

For example, the first secondary TF bin 705AD and the second secondary TF bin 705BD form a second pair of TF bins. For example, the first secondary TF bin 705AD is associated with a first secondary frequency band and a first secondary time instance. For example, the first secondary TF bin 705AD can be construed as a first secondary portion (e.g., a part) of the first frequency-domain signal 704AA (e.g., of the first electrical input signal 702AA), such portion being associated with the first secondary frequency band and the first secondary time instance. For example, the second secondary TF bin 705BD is associated with a second secondary frequency band and a second secondary time instance. For example, the second secondary TF bin 705BD can be construed as a second secondary portion (e.g., a part) of the second frequency-domain signal 704BA (e.g., of the second electrical input signal 702BA), such portion being associated with the second secondary frequency band and the second secondary time instance. The first secondary frequency band may be the same as the second secondary frequency band. The first secondary time instance may be the same as the second secondary time instance. For example, the first secondary TF bin 705AD and the second secondary TF bin 705BD share the same location (e.g., position) in the first plurality of TF bins 705A and second plurality of TF bins 705B respectively.

In one or more example hearing aids, the ultrasound processing unit 708 (e.g., the comparison and selection unit 722) is configured to determine the ultrasound processed signal 708A by selecting the TF bin comprising the lowest TF magnitude of each pair of TF bins.

In one or more example hearing aids, the first magnitude determination unit 720A is configured to determine a first (e.g., primary, secondary, tertiary, etc.) TF magnitude of a first (e.g., primary, secondary, tertiary, etc.) TF bin of each pair of TF bins. For example, the first magnitude determination unit 720A is configured to determine a first primary TF magnitude 720AC of the first primary TF bin 705AC of the first pair of TF bins. For example, the first magnitude determination unit 720A is configured to determine a first secondary TF magnitude 720AD of the first secondary TF bin 705AD of the second pair of TF bins. In other words, the first magnitude determination unit 720A may be configured to determine a magnitude of each portion (e.g., of a plurality of portions) of the first frequency-domain signal 704AA.

In one or more example hearing aids, the second magnitude determination unit 720B is configured to determine a second (e.g., primary, secondary, tertiary, etc.) TF magnitude of a second (e.g., primary, secondary, tertiary, etc.) TF bin of each pair of TF bins. For example, the second magnitude determination unit 720A is configured to determine a second primary TF magnitude 720BC of the second primary TF bin 705BC of the first pair of TF bins. For example, the second magnitude determination unit 720B is configured to determine a second secondary TF magnitude 720BD of the second secondary TF bin 705BD of the second pair of TF bins. In other words, the second magnitude determination unit 720B may be configured to determine a magnitude of each portion (e.g., of a plurality of portions) of the second frequency-domain signal 704BA.

In one or more example hearing aids, the comparison and selection unit 722 is configured to receive the first (e.g., primary, secondary, tertiary, etc.) TF magnitude and the second (e.g., primary, secondary, tertiary, etc.) TF magnitude of each pair of TF bins. In other words, the comparison and selection unit 722 may be configured to receive a first TF magnitude signal 720AA indicative of the first TF magnitude of each pair pf TF bins. For example, the first TF magnitude signal 720AA is indicative of the first primary TF magnitude 720AC and the first secondary TF magnitude 720AD. For example, the second TF magnitude signal 720BA is indicative of the second primary TF magnitude 720BC and the second secondary TF magnitude 720BD.

Optionally, the ultrasound processing unit 708 comprises a plurality of filtering units (not shown in FIGS. 4A-4B, e.g., filtering units 506A, 506B of FIG. 3) in communication with corresponding plurality of magnitude determination units 720A, 720B and with the comparison and selection unit 722. For example, the plurality of filtering units is configured to receive the corresponding plurality of TF magnitude signals 720AA, 720BA. In one or more example hearing aids, the plurality of filtering units is configured to provide a corresponding plurality of filtered magnitude signals. For example, the comparison and selection unit 722 is configured to receive a filtered version of the first TF magnitude signal 720AA and a filtered version of the second TF magnitude signal 720AA. Optionally, the first TF magnitude signal 720AA and the second TF magnitude signal 720AA can be seen as filtered signal (e.g., filtered by respective LPF filters). For example, filtering the corresponding plurality of TF magnitude signals 720AA, 720BA can allow for more steady patterns across time. For example, a filtering unit can be seen as low pass filtering unit and/or smoothing unit.

In one or more example hearing aids, the comparison and selection unit 722 is configured to determine, for each pair of TF bins, whether the first (e.g., primary, secondary, tertiary, etc.) TF magnitude is greater than the second (e.g., primary, secondary, tertiary, etc.) TF magnitude. For example, the comparison and selection unit 722 is configured to determine, for the first pair of TF bins, whether the first primary TF magnitude 720AC is greater than the second primary TF magnitude 720BC. For example, the comparison and selection unit 722 is configured to determine, for the second pair of TF bins, whether the first secondary TF magnitude 720AD is greater than the second secondary TF magnitude 720BD.

In the embodiment of FIG. 4B, the comparison and selection unit 722 is configured to determine that the first primary TF magnitude 720AC is less than the second primary TF magnitude 720BC. In the embodiment of FIG. 4B, the comparison and selection unit 722 is configured to, upon determining that the first primary TF magnitude 720AC is less than the second primary TF magnitude 720BC, select the first primary TF bin 705AC as the TF bin comprising the lowest TF magnitude of the first pair of TF bins (e.g., of the first primary TF bin 705AC and the second primary TF bin 705AD). In one or more example hearing aids, the comparison and selection unit 722 is configured to provide a first selection signal 722A indicative of the first primary TF bin 705AC. In the embodiment of FIG. 4B, selection of the first primary TF bin 705AC as the TF bin comprising the lowest TF magnitude of the first pair of TF bins is illustrated by the color black. For example, the color white illustrates the fact that the first secondary TF bin 705BC is the TF bin comprising the largest TF magnitude of the first pair of TF bins, thereby not being selected. For example, the first selection signal 722A can be seen as a first binary matrix comprising a plurality of elements, whose elements representing the TF bins of the plurality of first TF bins in black (e.g., selected) are illustrated as “1” and elements representing the TF bins of the plurality of first TF bins in white (e.g., not selected) are illustrated as “0”.

In the embodiment of FIG. 4B, the comparison and selection unit 722 is configured to determine that the first secondary TF magnitude 720AD is greater than the second secondary TF magnitude 720BD. In the embodiment of FIG. 4B, the comparison and selection unit 722 is configured to, upon determining that the first secondary TF magnitude 720AD is greater than the second secondary TF magnitude 720BD, select the second secondary TF bin 705BD as the TF bin comprising the lowest TF magnitude of the second pair of TF bins (e.g., of the first secondary TF bin 705AD and the second secondary TF bin 705BD). In one or more example hearing aids, the comparison and selection unit 722 is configured to provide a second selection signal 722B indicative of the second secondary TF bin 705BD. In the embodiment of FIG. 4B, selection of the second secondary TF bin 705BD as the TF bin comprising the lowest TF magnitude of the second pair of TF bins is illustrated by color black. For example, the color white illustrates the fact that the second primary TF bin 705AD is the TF bin comprising the largest TF magnitude of the second pair of TF bins, thereby not being selected. For example, the second selection signal 722A can be seen as a second binary matrix comprising a plurality of elements, whose elements representing the TF bins of the plurality of second TF bins in black (e.g., selected) are illustrated as “1” and elements representing the TF bins of the plurality of second TF bins in white (e.g., not selected) are illustrated as “0”.

In one or more example hearing aids, the generation unit 724 is configured to generate the ultrasound processed signal 708A based on the first selection signal 722A, the second selection signal 722B, the first frequency-domain signal 704AA, and the second frequency-domain signal 704BA. In other words, the ultrasound processed signal 708A may be seen as a linear combination of the plurality frequency-domain signals 704AA, 704BA (e.g., the first frequency-domain signal 704AA and the second frequency-domain signal 704AB) with a corresponding plurality of selection signals 722A, 722B (e.g., binary matrices and/or binary masks). For example, the ultrasound processed signal 708A can be seen as a linear combination of the first frequency-domain signals 704AA with the first selection signal 722A. For example, the ultrasound processed signal 708A can be seen as a linear combination of the second frequency-domain signals 704BA with the second selection signal 722B. For example, the ultrasound processed signal 708A can be seen as a linear combination of the first frequency-domain signals 704AA with the first selection signal 722A and of the second frequency-domain signals 704BA with the second selection signal 722B.

The ultrasound processed signal 708A (e.g., in the frequency domain) may be provided in a TF representation, in which TF bins having a pattern 20 illustrate the portions of the first frequency-domain signal 704AA (e.g., portions comprising the lowest magnitude in comparison with corresponding portions of the second frequency-domain signal 704BA) and TF bins having a pattern 10 illustrate the portions of the second frequency-domain signal 704AA (e.g., portions comprising the lowest magnitude in comparison with corresponding portions of the first frequency-domain signal 704AA).

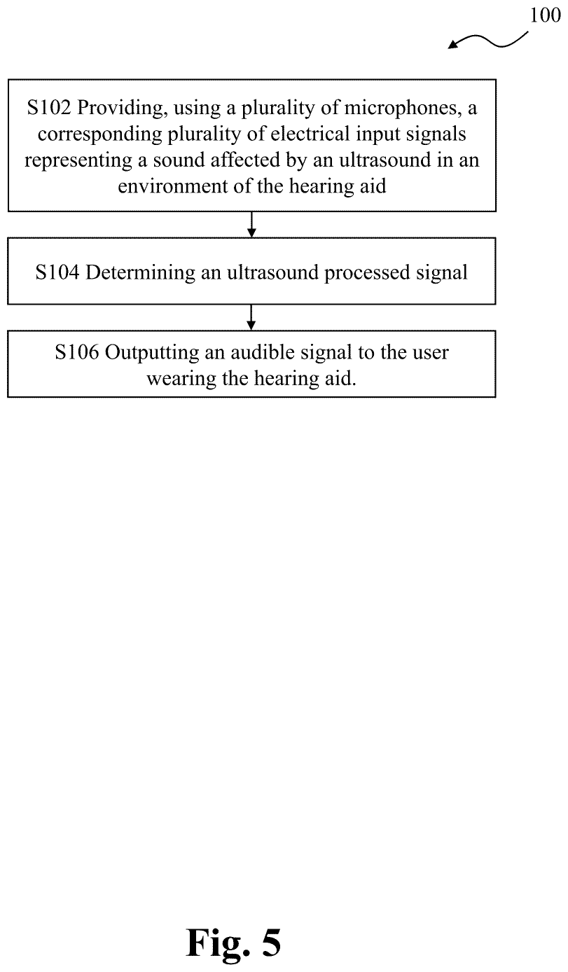

FIG. 5 illustrates a flow-chart of an example method 100 according to the present disclosure.

The method 100 comprises providing S102, using a plurality of microphones, a corresponding plurality of electrical input signals representing a sound affected by an ultrasound in an environment of the hearing aid. The ultrasound is characterized by an ultrasound frequency. Each of the plurality of electrical input signals is provided in a digitized form. The plurality of microphones being configured to have different port diameters such that sensitivities towards the ultrasound frequency are different among the plurality of microphones. The method 100 comprises determining S104, based on the different sensitivities towards the ultrasound frequency, an ultrasound processed signal. The method 100 comprises outputting S106, based on the ultrasound processed signal, an audible signal to the user wearing the hearing aid.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A hearing aid comprising:
an input unit comprising a plurality of microphones configured to provide a corresponding plurality of electrical input signals representing a sound affected by an ultrasound in an environment of the hearing aid, the ultrasound being characterized by an ultrasound frequency, wherein each of the plurality of electrical input signals is provided in a digitized form, and the plurality of microphones being configured to have different port diameters such that sensitivities towards the ultrasound frequency are different among the plurality of microphones;
an ultrasound processing unit in communication with the input unit, the ultrasound processing unit being configured to receive the plurality of electrical input signals, and determine, based on the different sensitivities towards the ultrasound frequency, an ultrasound processed signal; and
an output unit configured to output, based on the ultrasound processed signal, an audible signal to the user wearing the hearing aid.

2. The hearing aid according to claim 1, wherein each of the plurality of electrical input signals is a time-domain signal or a frequency-domain signal.

3. The hearing aid according to claim 1, wherein to determine the ultrasound processed signal comprises to:
select, based on the comparison, the ultrasound processed signal as the electrical input signal provided by the microphone of the plurality of microphones having the smallest port diameter among the plurality of microphones.

4. The hearing aid according to claim 1, wherein to determine the ultrasound processed signal comprises to:
compare the sensitivity associated with each of the plurality of microphones; and
select, based on the comparison, the ultrasound processed signal as the electrical input signal provided by the microphone of the plurality of microphones with the lowest sensitivity.

5. The hearing aid according to claim 1, wherein to determine the ultrasound processed signal comprises to:
determine a magnitude associated with each of the plurality of electrical input signals;
compare the magnitude associated with each of the plurality of electrical input signals; and
select, based on the comparison, the ultrasound processed signal as the electrical input signal of the plurality of electrical input signals comprising the lowest magnitude.

6. A hearing aid according to claim 1, wherein each of the plurality of electrical input signals is a frequency-domain signal in a time-frequency (TF) representation, wherein the plurality of electrical input signals comprises a first frequency-domain signal having a first plurality of TF bins and a second frequency-domain signal having a second plurality of TF bins, wherein a pair of TF bins comprises a first TF bin of the first plurality of TF bins and a corresponding second TF bin of the second plurality of TF bins, and wherein to determine the ultrasound processed signal comprises to select the TF bin comprising the lowest TF magnitude of each pair of TF bins.

7. A hearing aid according to claim 6, wherein to select the TF bin comprising the lowest TF magnitude of each pair of TF bins comprises to:
determine a first TF magnitude of the first TF bin of each pair of TF bins;
determine a second TF magnitude of the second TF bin of each pair of TF bins; and
determine, for each pair of TF bins, whether the first TF magnitude is greater than the second TF magnitude.

8. A hearing aid according to claim 7, wherein to determine whether the first TF magnitude is greater than the second TF magnitude comprises to:
determine that the first TF magnitude is greater than the second TF magnitude; and
upon determining that the first TF magnitude is greater than the second TF magnitude, select the second TF bin as the TF bin comprising the lowest TF magnitude of each pair of TF bins.

9. A hearing aid according to claim 7, wherein to determine whether the first TF magnitude is greater than the second TF magnitude comprises to:
determine that the first TF magnitude is less than the second TF magnitude; and
upon determining that the first TF magnitude is less than the second TF magnitude, select the first TF bin as the TF bin comprising the lowest TF magnitude of each pair of TF bins.

10. A hearing aid according to claim 7, wherein to determine whether the first magnitude is greater than the second magnitude comprises to:
determine that the first magnitude is equal the second magnitude; and
upon determining that the first magnitude is equal to the second magnitude, select the first time-frequency bin of the pair of time-frequency bins or the second time-frequency bin as the time-frequency bin comprising the lowest magnitude of each pair of time-frequency bins.

11. The hearing aid according to claim 1, wherein the ultrasound processing unit comprises a plurality of filtering units configured to receive the corresponding plurality of electrical input signals, and provide a corresponding plurality of filtered electrical input signals, wherein to determine the ultrasound processed signal is based on the plurality of filtered electrical input signals.

12. The hearing aid according to claim 1, wherein the ultrasound processing unit is in communication with a gain unit, the gain unit being configured to provide a second ultrasound processed signal by applying a gain to the ultrasound processed signal, and wherein the output unit is configured to output the audible sound signal to the user wearing the hearing aid based on the second ultrasound processed signal.

13. A method of operating a hearing aid, the method comprising:
providing, using a plurality of microphones, a corresponding plurality of electrical input signals representing a sound affected by an ultrasound in an environment of the hearing aid, the ultrasound being characterized by an ultrasound frequency, wherein each of the plurality of electrical input signals is provided in a digitized form, and the plurality of microphones being configured to have different port diameters such that sensitivities towards the ultrasound frequency are different among the plurality of microphones;
determining, based on the different sensitivities towards the ultrasound frequency, an ultrasound processed signal; and
outputting, based on the ultrasound processed signal, an audible signal to the user wearing the hearing aid.
